(19) United States
(12) Patent Application Publication
(10) Pub. No.: US 2026/0067981 A1
(43) Pub. Date: Mar. 5, 2026

(54) COMMUNICATION METHOD

(71) Applicant: KYOCERA Corporation, Kyoto (JP)

(72) Inventors: Masato FUJISHIRO, Yokohama-shi (JP); Henry CHANG, San Diego, CA (US)

(73) Assignee: KYOCERA Corporation, Kyoto (JP)

(21) Appl. No.: 19/384,654

(22) Filed: Nov. 10, 2025

Related U.S. Application Data
(63) Continuation of application No. PCT/JP2024/017463, filed on May 10, 2024.
(60) Provisional application No. 63/501,461, filed on May 11, 2023.

(51) Int. Cl. H04W 76/27; H04W 76/40

(52) U.S. Cl. CPC H04W 76/27; H04W 76/40

(57) ABSTRACT

A communication method performed by a user equipment in a mobile communication system configured to provide a multicast/broadcast service (MBS), the communication method including receiving, from a network, information for configuring a resume condition for initiating a radio resource control (RRC) connection resume at a time of multicast reception in an RRC inactive state, the resume condition being related to multicast reception quality, receiving, from the network, information for configuring an area condition for an area in which the RRC connection resume based on the resume condition is permitted or prohibited, and initiating the RRC connection resume when the resume condition is satisfied and the area condition is satisfied at a time of multicast reception in the RRC inactive state.

### RELATED APPLICATIONS

The present application is a continuation based on PCT Application No. PCT/JP2024/017463, filed on May 10, 2024, which claims the benefit of U.S. Provisional Patent Application No. 63/501,461 filed on May 11, 2023. The content of which is incorporated by reference herein in their entirety.

### TECHNICAL FIELD

The present disclosure relates to a communication method used in a mobile communication system.

### BACKGROUND

The 3rd Generation Partnership Project (3GPP) has defined the technical specifications of New Radio (NR) that is a radio access technology of the fifth generation (5G). NR has features such as high speed, large capacity, high reliability, and low latency as compared to Long Term Evolution (LTE) that is a radio access technology of the fourth generation (4G). The 3GPP has defined technical specifications of multicast/broadcast services (MBS) of 5G/NR.

In 3GPP Release 17, MBS multicast reception (i.e., multicast reception) is possible only for a user equipment in a radio resource control (RRC) connected state (see, for example, Non-Patent Document 1). On the other hand, in 3GPP Release 18, technical specifications are scheduled to be extended so that a user equipment in an RRC inactive state can perform multicast reception.

### CITATION LIST

### Non-Patent Literature

Non-Patent Document 1: 3GPP Technical Specification: TS 38.300 V17.4.0

### SUMMARY

In a first aspect, a communication method performed by a user equipment in a mobile communication system configured to provide a multicast/broadcast service (MBS) includes receiving, from a network, a reception quality threshold for initiating a radio resource control (RRC) connection resume at a time of multicast reception in an RRC inactive state, the reception quality threshold being associated with a multicast session, and initiating the RRC connection resume in response to reception quality falling below the reception quality threshold at a time of multicast reception in the RRC inactive state.

In a second aspect, a communication method performed by a user equipment in a mobile communication system configured to provide a multicast/broadcast service (MBS) includes receiving, from a network, information for configuring a resume condition for initiating a radio resource control (RRC) connection resume at a time of multicast reception in an RRC inactive state, the resume condition being related to multicast reception quality, receiving, from the network, information for configuring an area condition for an area in which the RRC connection resume based on the resume condition is permitted or prohibited, and initiating the RRC connection resume when the resume condition is satisfied and the area condition is satisfied at a time of multicast reception in the RRC inactive state.

In a third aspect, a communication method performed by a user equipment in a mobile communication system configured to provide a multicast/broadcast service (MBS) includes receiving, from a network, information for configuring a resume condition for initiating a radio resource control (RRC) connection resume at a time of multicast reception in an RRC inactive state, the resume condition being related to multicast reception quality, the information including information for configuring, as the resume condition, a resume condition different for each of combinations of a serving cell and a neighbor cell, and initiating the RRC connection resume in response to the resume condition associated with a combination of a current serving cell and a current neighbor cell being satisfied at a time of multicast reception in the RRC inactive state.

In a fourth aspect, a communication method performed by a user equipment in a mobile communication system configured to provide a multicast/broadcast service (MBS) includes receiving, from a network, information for configuring a resume condition for initiating a radio resource control (RRC) connection resume at a time of multicast reception in an RRC inactive state, the resume condition being related to multicast reception quality, the resume condition including a reception quality threshold to be compared with a multicast reception quality of a physical downlink shared channel (PDSCH) associated with a multicast traffic channel (MTCH), and initiating the RRC connection resume in response to reception quality of the PDSCH associated with the MTCH in the multicast reception satisfying a condition of the reception quality threshold at a time of multicast reception in the RRC inactive state.

In a fifth aspect, a communication method performed by a user equipment in a mobile communication system configured to provide a multicast/broadcast service (MBS) includes determining whether a user equipment is configured, from a network, with a resume condition for initiating a radio resource control (RRC) connection resume at a time of multicast reception in an RRC inactive state, the resume condition being related to multicast reception quality, and considering that the RRC connection resume for the multicast reception is prohibited from being initiated at a time of multicast reception in the RRC inactive state, based on a result of the determining.

In a sixth aspect, a communication method performed by a user equipment in a mobile communication system configured to provide a multicast/broadcast service (MBS) includes receiving, from a network, information for configuring a resume condition for initiating a radio resource control (RRC) connection resume at a time of multicast reception in an RRC inactive state, the resume condition being related to multicast reception quality, initiating the RRC connection resume in response to the resume condition being satisfied at a time of multicast reception in the RRC inactive state, and notifying the network that the resume condition is satisfied in a procedure of the RRC connection resume.

In a seventh aspect, a communication method performed by a user equipment in a mobile communication system configured to provide a multicast/broadcast service (MBS) includes receiving, from a network, information for configuring a resume condition for initiating a radio resource control (RRC) connection resume at a time of multicast reception in an RRC inactive state, the resume condition being related to multicast reception quality, initiating the RRC connection resume in response to the resume condition being satisfied at a time of multicast reception in the RRC inactive state, wherein the receiving includes receiving the information for configuring a plurality of the resume conditions corresponding to a plurality of multicast sessions received by the user equipment, and the initiating includes initiating the RRC connection resume in response to at least one of the plurality of the resume conditions being satisfied.

### BRIEF DESCRIPTION OF THE DRAWINGS

FIG. 1 is a diagram illustrating a configuration example of a mobile communication system according to an embodiment.

FIG. 2 is a diagram illustrating a configuration example of a UE (user equipment) according to an embodiment.

FIG. 3 is a diagram illustrating a configuration example of a gNB (base station) according to the embodiment.

FIG. 4 is a diagram illustrating a configuration of a protocol stack of a radio interface of a user plane handling data.

FIG. 5 is a diagram illustrating a configuration of a protocol stack of a radio interface of a control plane handling signaling (control signal).

FIG. 6 is a diagram for explaining an operation scenario for a first operation pattern according to the embodiment.

FIG. 7 is a flowchart illustrating an example of an operation of the UE for the first operation pattern according to the embodiment.

FIG. 8 is a diagram illustrating an example of an operation of the mobile communication system for the first operation pattern according to the embodiment.

FIG. 9 is a flowchart illustrating an example of an operation of the UE for a second operation pattern according to the embodiment.

FIG. 10 is a diagram illustrating an example of an operation of the mobile communication system for the second operation pattern according to the embodiment.

FIG. 11 is a flowchart illustrating an example of an operation of the UE for a third operation pattern according to the embodiment.

FIG. 12 is a diagram illustrating an example of an operation of the mobile communication system for the third operation pattern according to the embodiment.

FIG. 13 is a flowchart illustrating an example of an operation of the UE for a fourth operation pattern according to the embodiment.

FIG. 14 is a flowchart illustrating another example of the operation of the UE for the fourth operation pattern according to the embodiment.

FIG. 15 is a flowchart illustrating an example of an operation of the UE for a fifth operation pattern according to the embodiment.

FIG. 16 is a diagram illustrating an example of an operation of the mobile communication system for the fifth operation pattern according to the embodiment.

FIG. 17 is a diagram illustrating an example of an operation of the mobile communication system for a sixth operation pattern according to the embodiment.

FIG. 18 is a diagram illustrating an initial configuration procedure of an on-going session (FIG. 18A) and a deactivated session (FIG. 18B).

### DESCRIPTION OF EMBODIMENTS

According to an embodiment, a mobile communication system is described with reference to the drawings. In the description of the drawings, the same or similar parts are denoted by the same or similar reference signs.

### (1) System Configuration Example

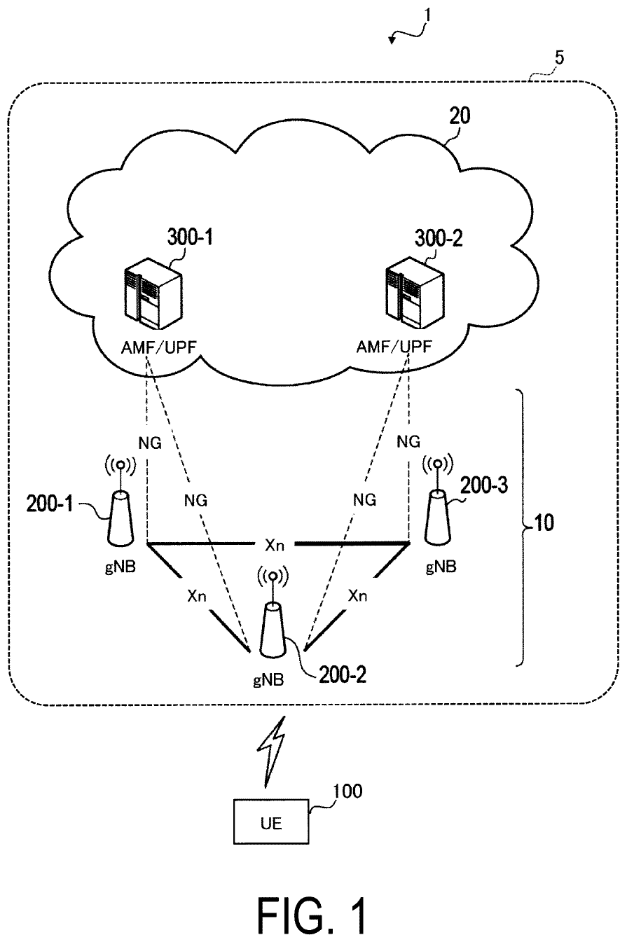

FIG. 1 is a diagram illustrating a configuration example of a mobile communication system 1 according to the embodiment. The mobile communication system 1 complies with the 5th Generation System (5GS) of the 3GPP standard. The description below takes the 5GS as an example, but Long Term Evolution (LTE) system may be at least partially applied to the mobile communication system. Alternatively, a sixth generation (6G) system may be at least partially applied to the mobile communication system.

The mobile communication system 1 includes User Equipment (UE) 100, a 5G radio access network (Next Generation Radio Access Network (NG-RAN)) 10, and a 5G Core Network (5GC) 20. Hereinafter, the NG-RAN 10 may be simply referred to as a RAN 10. The 5GC 20 may be simply referred to as a core network (CN) 20. The RAN 10 and the CN 20 constitute a network of the mobile communication system 1.

The UE 100 is a mobile wireless communication apparatus. The UE 100 may be any apparatus as long as the UE 100 is used by a user. Examples of the UE 100 include a mobile phone terminal (including a smartphone) and/or a tablet terminal, a notebook PC, a communication module (including a communication card or a chipset), a sensor or an apparatus provided on a sensor, a vehicle or an apparatus provided on a vehicle (Vehicle UE), and a flying object or an apparatus provided on a flying object (Aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter, simply referred to as a “frequency”).

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface which is an interface between a base station and the core network.

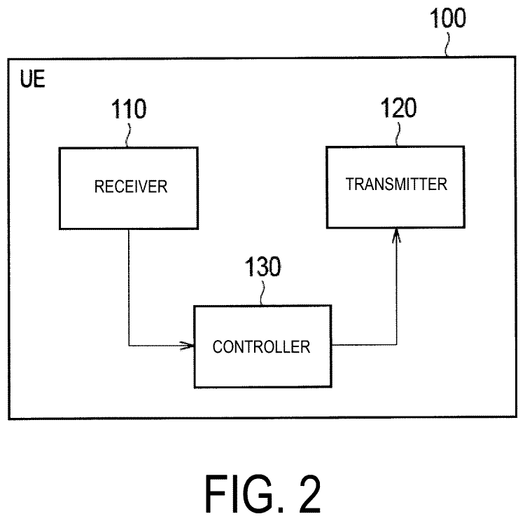

FIG. 2 is a diagram illustrating a configuration example of the UE 100 (user equipment) according to the embodiment. The UE 100 includes a receiver 110, a transmitter 120, and a controller 130. The receiver 110 and the transmitter 120 constitute a wireless communicator that performs wireless communication with the gNB 200.

The receiver 110 performs various receptions under the control of the controller 130. The receiver 110 includes an antenna and a reception device. The reception device converts a radio signal or a terahertz wave signal received through the antenna into a baseband signal (a reception signal) and outputs the resulting signal to the controller 130.

The transmitter 120 performs various transmissions under the control of the controller 130. The transmitter 120 includes an antenna and a transmission device. The transmission device converts a baseband signal (a transmission signal) output by the controller 130 into a radio signal or a terahertz wave signal and transmits the resulting signal through the antenna.

The controller 130 performs various controls and processes in the UE 100. Such processing includes processing of respective layers to be described later. The operations of the UE 100 described above and below may be operations under the control of a controller 230. The controller 130 includes at least one processor and at least one memory. The memory stores a program to be executed by the processor and information to be used for processing in the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing.

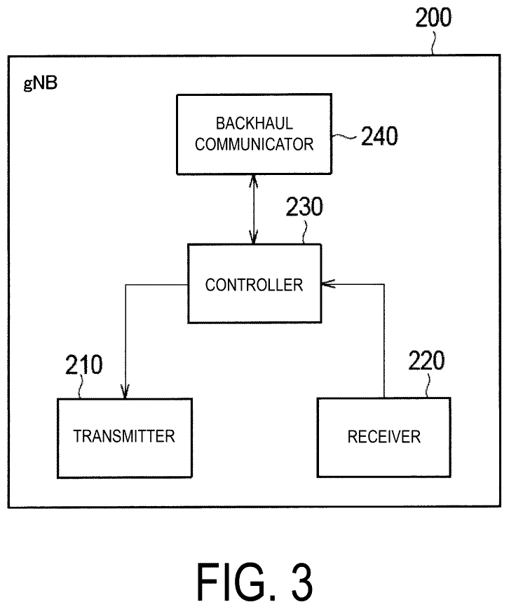

FIG. 3 is a diagram illustrating a configuration example of the gNB 200 (the base station) according to the embodiment. The gNB 200 includes a transmitter 210, a receiver 220, a controller 230, and a backhaul communicator 240. The transmitter 210 and the receiver 220 constitute a wireless communicator that performs wireless communication with the UE 100. The backhaul communicator 240 constitutes a network communicator that performs communication with the CN 20.

The transmitter 210 performs various transmissions under the control of the controller 230. The transmitter 210 includes an antenna and a transmission device. The transmission device converts a baseband signal (a transmission signal) output by the controller 230 into a radio signal or a terahertz wave signal and transmits the resulting signal through the antenna.

The receiver 220 performs various types of reception under control of the controller 230. The receiver 220 includes an antenna and a reception device. The reception device converts a radio signal or a terahertz wave signal received through the antenna into a baseband signal (a reception signal) and outputs the resulting signal to the controller 230.

The controller 230 performs various types of control and processing in the gNB 200. Such processing includes processing of respective layers to be described later. The operations of the gNB 200 described above and below may be also performed under the control of the controller 230. The controller 230 includes at least one processor and at least one memory. The memory stores a program to be executed by the processor and information to be used for processing in the processor. The processor may include a baseband processor and a CPU. The baseband processor performs modulation and demodulation, coding and decoding, and the like of a baseband signal. The CPU executes the program stored in the memory to thereby perform various types of processing.

The backhaul communicator 240 is connected to a neighboring base station via an Xn interface which is an inter-base station interface. The backhaul communicator 240 is connected to the AMF/UPF 300 via an NG interface which is an interface between a base station and the core network. Note that the gNB 200 may include a Central Unit (CU) and a Distributed Unit (DU) (i.e., functions are divided), and both units may be connected via an F1 interface that is a fronthaul interface.

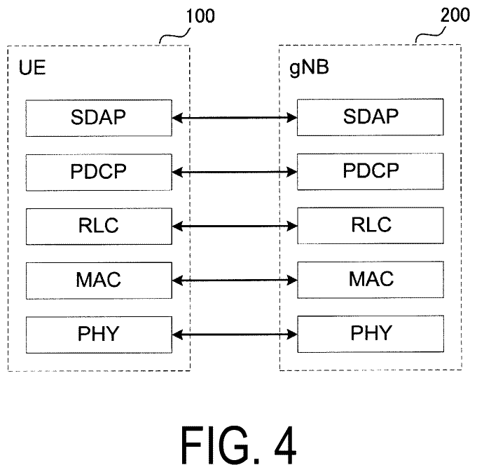

FIG. 4 is a diagram illustrating a configuration of a protocol stack of a radio interface of a user plane handling data.

A radio interface protocol of the user plane includes a PHYsical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs encoding/decoding, modulation/demodulation, antenna mapping/demapping, and resource mapping/demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 performs blind decoding of the PDCCH by using a radio network temporary identifier (RNTI) and acquires a successfully decoded DCI as a DCI addressed to the UE. The DCI transmitted from the gNB 200 is appended with CRC (cyclic redundancy code) parity bits scrambled by the RNTI.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow as the unit of Quality of Service (QoS) control performed by a core network and a radio bearer as the unit of QoS control performed by an Access Stratum (AS). Note that, when the RAN is connected to the EPC, the SDAP need not be provided.

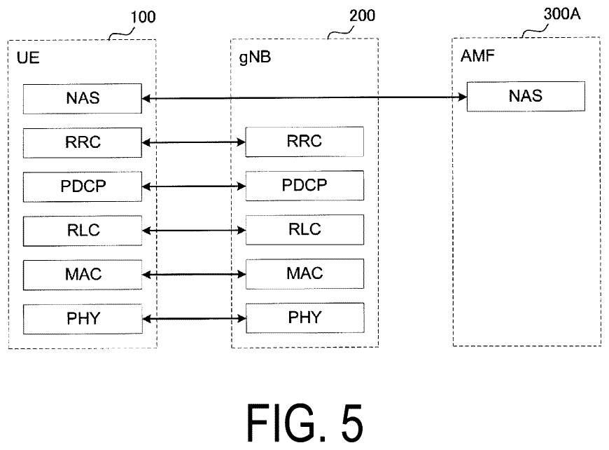

FIG. 5 is a diagram illustrating a configuration of a protocol stack of a radio interface of a control plane handling signaling (a control signal).

The protocol stack of the radio interface of the control plane includes a Radio Resource Control (RRC) layer and a Non-Access Stratum (NAS) layer instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When connection (RRC connection) is established between RRC of the UE 100 and RRC of the gNB 200, the UE 100 is in an RRC connected state. When connection (RRC connection) is not established between the RRC of the UE 100 and the RRC of the gNB 200, the UE 100 is in an RRC idle state. When the connection between the RRC of the UE 100 and the RRC of the gNB 200 is suspended, the UE 100 is in an RRC inactive state.

The NAS layer (also simply referred to as “NAS”), which is located above the RRC layer, performs session management, mobility management, and the like. NAS signaling is transmitted between the NAS layer of the UE 100 and the NAS layer of an AMF 300A. The UE 100 includes an application layer other than the protocol of the radio interface. The layer below the NAS layer is referred to as an AS layer (also simply referred to as “AS”).

### (2) Overview of MBS

The mobile communication system 1 can perform delivery with high resource efficiency by using the multicast/broadcast service (MBS).

### (2.1) MBS Broadcast

In a case of the broadcast communication services (also referred to as “MBS broadcast”), the same service and the same specific content data are provided simultaneously to every UE 100 in a geographic area. That is, every UE 100 in the broadcast service area is permitted to receive the data. The broadcast communication services are delivered to the UE 100 using a broadcast session that is a type of MBS session. The UE 100 can receive the broadcast session in any state of the RRC idle state, the RRC inactive state, and the RRC connected state. Note that the MBS session is identified by an MBS session ID (e.g., Temporary Mobile Group Identity (TMGI)).

Point-to-Multipoint (PTM) delivery is applied to the broadcast communication service. For the PTM transmission, the gNB 200 delivers a single copy of an MBS packet to a set (group) of a plurality of UEs 100. For example, the gNB 200 uses a group-common PDCCH with a CRC scrambled by a group-common RNTI (G-RNTI) to schedule a group-common PDSCH scrambled by the G-RNTI.

For the broadcast communication service, the UE 100 receives a broadcast session in the following procedure. First, the UE 100 receives system information block type 20 (SIB20) from the gNB 200. The SIB20 includes a configuration of a multicast control channel (MCCH), which is a type of logical channel. Second, the UE 100 receives the MCCH from the gNB 200 based on the SIB20. The MCCH includes a PTM configuration. The PTM configuration carries a configuration for a multicast traffic channel (MTCH), which is a type of logical channel, and a configuration of a broadcast multicast radio bearer (MRB), which is an MRB for broadcast session. The information transmitted by the MCCH may be referred to as MBS broadcast control information. Third, the UE 100 receives the MTCH based on the MCCH. The MTCH transmits a broadcast session (specifically, MBS data belonging to the broadcast session).

Note that the MCCH is a PTM downlink channel for transmitting the MBS broadcast control information associated with one or more MTCHs from the network 10 to the UE 100. The MTCH is a PTM downlink channel for transmitting MBS data of a multicast session and/or a broadcast session from the network 10 to the UE 100.

### (2.2) MBS Multicast

For a multicast communication service (also referred to as “MBS multicast”), the same service and the same specific content data are simultaneously provided to a specific UE set. That is, not every UE 100 in the multicast service area is permitted to receive data. The multicast communication service is delivered to the UE 100 using a multicast session that is a type of MBS session.

The UE 100 can receive a multicast session only after joining the multicast session (session join). The joining the multicast session may mean that the UE 100 is registered as being capable of receiving the multicast session in the network 5 (the CN 20).

For the multicast communication service, in 3GPP Release 17, only the UE 100 in the RRC connected state can receive a multicast session. On the other hand, in 3GPP Release 18, enhancement will be made such that the UE 100 in the RRC inactive state also can receive a multicast session.

### (2.2.1) Multicast Reception in RRC Connected State

The UE 100 in the RRC connected state can receive a multicast session (specifically, MBS data belonging to a multicast session) by using mechanisms such as Point-to-Point (PTP) delivery and/or Point-to-Multipoint (PTM) delivery.

For the multicast communication service, the UE 100 in the RRC connected state receives a multicast session in the following procedure. First, the UE 100 receives an RRC Reconfiguration message from the gNB 200. The RRC Reconfiguration message is a message transmitted on a dedicated control channel (DCCH). The RRC Reconfiguration message transmits a configuration for an MTCH for multicast session reception and a configuration of a multicast MRB which is an MRB for multicast session. Second, the UE 100 receives an MTCH based on the RRC Reconfiguration message. The MTCH transmits a multicast session (specifically, MBS data belonging to the multicast session). Note that the configuration for the MTCH (MTCH configuration), is a configuration for MTCH reception, and includes, for example, at least one selected from the group consisting of a group identifier (G-RNTI), a discontinuous reception configuration (DRX configuration or scheduling information: MTCH transmission ON time, MTCH transmission cycle, reference time and time offset, HARQ retransmission configuration), a layer 2 configuration (PDCP configuration, RLC configuration), and a physical channel configuration (PDCCH configuration, PDSCH configuration, SSB mapping configuration).

### (2.2.2) Multicast Reception in RRC Inactive State

The UE 100 in the RRC inactive state may receive a multicast session (specifically, MBS data belonging to the multicast session) by using the mechanism of the PTM delivery.

For the multicast communication service, the UE 100 in the RRC inactive state can receive a multicast session in the following procedure. First, the UE 100 in the RRC inactive state receives a newly introduced system information block (also referred to as a “new SIB”) from the gNB 200. The new SIB includes a configuration of a newly introduced MCCH (also referred to as a “multicast MCCH”). Second, the UE 100 in the RRC inactive state receives a multicast MCCH based on the new SIB from the gNB 200. The multicast MCCH includes a PTM configuration. The PTM configuration carries a configuration for an MTCH for multicast session reception and a configuration of a multicast MRB which is an MRB for multicast session. Third, the UE 100 in the RRC inactive state receives an MTCH based on the multicast MCCH. The MTCH transmits a multicast session (specifically, MBS data belonging to the multicast session).

When the gNB 200 configures the UE 100 to receive multicast in the RRC inactive state, the gNB 200 can transmit the PTM configuration using an RRC release message including a suspend configuration to the UE 100. In this case, the UE 100, upon receiving the RRC Release message including the PTM configuration from the gNB 200, transitions to the RRC inactive state and receives the multicast session in the RRC inactive state.

### (3) Example of System Operation

Hereinafter, an operation for the multicast reception in the RRC inactive state is described. In the present embodiment, assume a scenario in which the UE 100 in the RRC inactive state performs reception of a multicast session (also referred to as multicast reception). The UE 100 in the RRC inactive state performing the multicast reception can reduce a load (resource consumption and/or power consumption) on the network 5 and the UE 100, compared to when the UE 100 in the RRC connected state performs the multicast reception.

Currently, in the 3GPP, a discussion is made on introducing to the UE 100 a function of transitioning to the RRC connected state by initiating (triggering) an RRC connection resume when reception quality of multicast data (also referred to as “multicast reception quality”) falls below a configured threshold. Such a function is considered to make it easy for the UE 100 to continue the multicast reception. However, problems exist that specific contents are not determined as to what measurement values are used as the multicast reception qualities, how to configure the thresholds for the UE 100, and the like.

A condition that the multicast reception quality falls below the configured threshold and conditions similar to this are also referred to as “resume conditions”. In the following embodiment, first to sixth operation patterns for performing appropriate control regarding the RRC connection resume based on the resume conditions are described. Each of the first to sixth operation patterns may be performed independently, or two or more operation patterns may be combined and performed.

### (3.1) First Operation Pattern

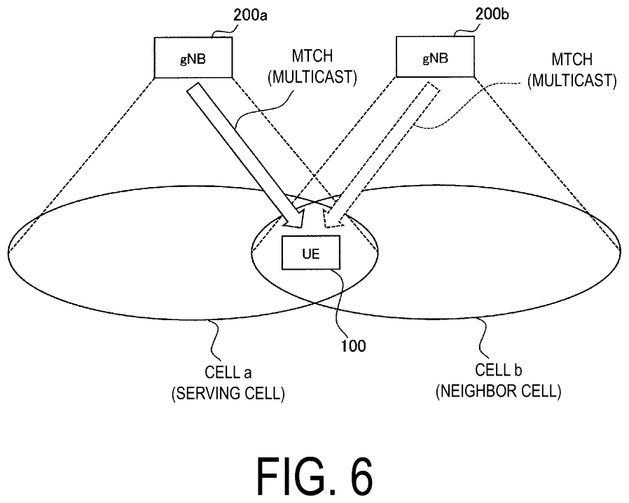

FIG. 6 is a diagram for explaining an operation scenario for the first operation pattern according to the embodiment. In the illustrated example, the UE 100 selects a cell a of a gNB 200a as a serving cell for the UE 100 itself, and performs multicast reception in the RRC inactive state. The UE 100 is located in an overlapping region of the cell a, which is the serving cell, and a cell b, which is a neighbor cell. The cell b is managed by a gNB 200b different from the gNB 200a that is a serving gNB, but the cell b may also be managed by the gNB 200a. Assume that the multicast session received by the UE 100 in the RRC inactive state on the MTCH of the cell a is a multicast session #1.

When the cell a and the cell b constitute a single frequency network (SFN), the cell b may provide the multicast session #1 on the MTCH for which the time/frequency resources are the same as for the MTCH of the cell a. And/or, when the same PTM configuration is applied to the cell a and the cell b, that is, when an area-specific PTM configuration is applied to the cell a and the cell b, the cell b may provide the multicast session #1 on the MTCH for which the time/frequency resources are the same as for the MTCH of the cell a. In such a case, the UE 100 in the RRC inactive state can receive the MTCH of the cell a and receive the MTCH of the cell b. Therefore, even in a case that the multicast reception quality from the cell a is degraded, the multicast reception quality from the cell b may be good.

Here, assume that, as the resume condition, thresholds for the reception qualities of the reference signals specific to the cell a, for example, thresholds of the reference signal received power (RSRP) and/or thresholds of the reference signal received qualities (RSRQ) are configured for the UE 100. The reference signals specific to the cell a may be a reference signal included in a synchronization signal/PBCH block (SSB) of the cell a. In this case, even in a case that the multicast reception quality from the cell b is good, the UE 100 may initiate the RRC connection resume for the cell a in response to the multicast reception quality from the cell a falling below the threshold. That is, even when the multicast session #1 is successfully received from the cell b and the RRC connection resume does not need to be performed, the UE 100 performs unnecessary RRC connection resume.

The first operation pattern is an operation pattern to make it easy to prevent the UE 100 from performing unnecessary RRC connection resume by restricting the initiation of the RRC connection resume based on the multicast reception qualities in consideration of the area (cell) in which the UE 100 is located.

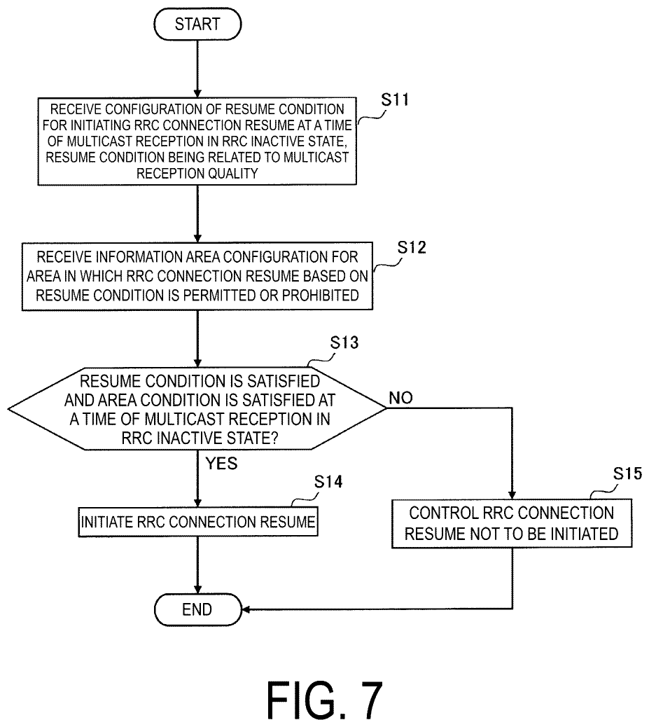

FIG. 7 is a flowchart illustrating an example of the operation of the UE 100 for the first operation pattern according to the embodiment.

In step S11, the UE 100 in the RRC inactive state at a time of multicast reception receives, from the network 5, information for configuring a resume condition for initiating the RRC connection resume, the resume condition being in terms of multicast reception quality. The information is, for example, information indicating the RSRP threshold and/or the RSRP threshold for the serving cell. The resume condition may be a condition for performing cell reselection, for example, information indicating that the reception quality of the neighbor cell has become higher than the reception quality of the serving cell.

In step S12, the UE 100 receives, from the network 5, information for configuring an area condition for an area in which the RRC connection resume based on the resume condition is permitted or prohibited. Note that step S12 may be performed after or simultaneously with step S11.

The area condition may be a condition that the UE 100 is not located in the area consisting of a group of cells constituting the SFN, or a condition that the UE 100 is located in the area consisting of a group of cells not constituting the SFN.

The area condition may be a condition that the UE 100 is not located in the area consisting of a group of cells to which a common PTM configuration is applied, or a condition that the UE 100 is located in the area consisting of a group of cells to which the common PTM configuration is not applied.

The area condition may be a condition that the UE 100 is located in the area consisting of a group of cells in which the RRC connection resume based on the resume condition is permitted, or a condition that the UE 100 is not located in the area consisting of a group of cells in which the RRC connection resume based on the resume condition is prohibited.

In step S13, the UE 100 in the RRC inactive state upon performing multicast reception determines whether the resume condition is satisfied and the area condition is satisfied.

If a determination is made that the resume condition is satisfied and the area condition is satisfied (step S13: YES), in step S14, the UE 100 in the RRC inactive state upon performing multicast reception initiates the RRC connection resume and transitions to the RRC connected state.

On the other hand, if NO in step S13, in step S15, the UE 100 in the RRC inactive state upon performing multicast reception controls the RRC connection resume not to be initiated. For example, the UE 100 controls the RRC connection resume based on the resume condition not to be initiated when the area condition is not satisfied even with the resume condition being configured.

According to such an operation, even when the resume condition is satisfied, the UE 100 in the RRC inactive state upon performing multicast reception can maintain the RRC inactive state without initiating the RRC connection resume, when, for example, the UE 100 is camping on the serving cell constituting the SFN or the serving cell to which the common PTM configuration is applied. This makes it easy to keep the UE 100 from performing unnecessary RRC connection resume.

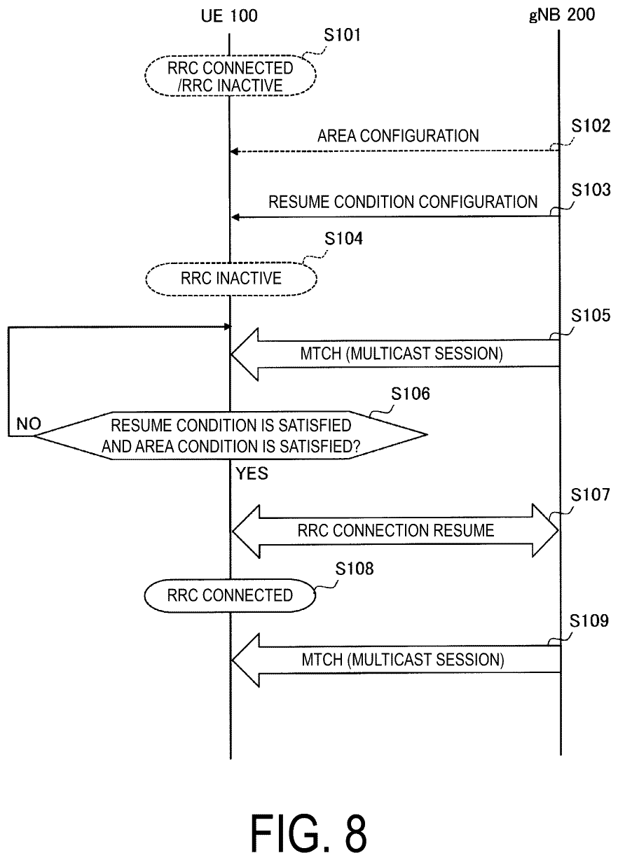

FIG. 8 is a diagram illustrating an example of an operation of the mobile communication system 1 for the first operation pattern according to the embodiment. Note that in the following description of the embodiment, it is assumed that the UE 100 has already joined a certain multicast session (referred to as a multicast session #1).

In step S101, the UE 100 is in the RRC connected state or the RRC inactive state in the cell (serving cell) of the gNB 200.

In step S102, the gNB 200 transmits an area configuration for the area condition to the UE 100. The UE 100 receives the area configuration from the gNB 200 (the current serving cell).

The gNB 200 may transmit the area configuration in dedicated signaling, for example, an RRC Release message or an RRC Reconfiguration message, to the UE 100 in the RRC connected state. The gNB 200 may transmit the area configuration in broadcast signaling, for example, an MCCH or an SIB, to the UE 100 in the RRC connected state or the RRC inactive state.

The area configuration may include common PTM configuration area information indicating a common PTM configuration area to which the common PTM configuration is applied. The common PTM configuration area information may be a list of cells (cell ID list) constituting the common PTM configuration area. The common PTM configuration area information transmitted in the current serving cell may be a list (cell ID list) of other cells to which the PTM configuration provided in the current serving cell is applied.

The area configuration may include common MCCH configuration area information indicating a common MCCH configuration area to which a common MCCH configuration is applied. The common MCCH configuration area information may be a list of cells (cell ID list) constituting the common MCCH configuration area. The common MCCH configuration area information transmitted in the current serving cell may be a list (cell ID list) of other cells to which the MCCH configuration provided in the SIB20 of the current serving cell is applied.

The area configuration may include SFN area information indicating an SFN area to which the SFN is applied. The SFN area information may be a list of cells (cell ID list) constituting the SFN area. The SFN area information transmitted in the current serving cell may be a list (cell ID list) of other cells constituting the SFN together with the current serving cell.

In step S103, the gNB 200 transmits a resume condition configuration for configuring the resume condition to the UE 100. The UE 100 receives the resume condition configuration from the gNB 200.

The gNB 200 may transmit the resume condition configuration in dedicated signaling, for example, an RRC Release message or an RRC Reconfiguration message, to the UE 100 in the RRC connected state. The gNB 200 may transmit the resume condition configuration in broadcast signaling, for example, an MCCH or an SIB, to the UE 100 in the RRC connected state or the RRC inactive state.

The resume condition configuration is, for example, information indicating the reception quality threshold (e.g., RSRP threshold and/or RSRP threshold, or the like) for the serving cell. The resume condition configuration may be information indicating a condition for performing cell reselection, for example, indicating that the reception quality of the neighbor cell has become higher than the reception quality of the serving cell.

The resume condition configuration may include information indicating an area in which the RRC connection resume based on the resume condition is prohibited (disabled, ignored). The information may be information referring to the common PTM configuration area (or the common MCCH configuration area) configured in step S102. The information may be information referring to the SFN area configured in step S102. The information may be a list of cell IDs of cells constituting an area in which the RRC connection resume based on the resume condition is prohibited (disabled or ignored).

The resume condition configuration may include information indicating an area in which the RRC connection resume based on the resume condition is permitted (enabled, applied). The information may be information indicating that the cell does not belong to the common PTM configuration area (or the common MCCH configuration area) configured in step S102. The information may be information indicating that the cell does not belong to the SFN area configured in step S102. The information may be a list of cell IDs of cells constituting an area in which the RRC connection resume based on the resume condition is permitted (enabled, applied).

The resume condition configuration may include information indicating that the RRC connection resume based on the resume condition is permitted (enabled, applied) regardless of the area.

In steps S104 and S105, the UE 100 in the RRC inactive state receives the multicast session #1 on the MTCH from the gNB 200 based on the PTM configuration provided on the MCCH by the gNB 200. The UE 100 may receive the multicast session #1 on the MTCH from the gNB 200 based on the PTM configuration provided in the RRC Release message.

In step S106, the UE 100 in the RRC inactive state determines whether the resume condition is satisfied and the area condition is satisfied. The UE 100 may evaluate whether the resume condition is satisfied only the area in which the RRC connection resume based on the resume condition is permitted (enabled, applied). The UE 100 may not need to evaluate whether the resume condition is satisfied in the area in which the RRC connection resume based on the resume condition is prohibited (disabled, ignored). The UE 100 may evaluate whether the resume condition is satisfied only during the multicast reception in the RRC inactive state. Being during the multicast reception may mean at least one selected from the group consisting of having joined the multicast session #1, the multicast session #1 having been activated, and having started reception of the multicast session #1 on the MTCH.

If it is not determined that the resume condition is satisfied and the area condition is satisfied (step S106: NO), the process returns to step S105. On the other hand, if a determination is made that the resume condition is satisfied and the area condition is satisfied (step S106: YES), the RRC connection resume is performed with the gNB 200 in step S107. The RRC connection resume includes transmitting an RRC Resume Request message from the UE 100 to the gNB 200 and transmitting an RRC Resume message from the gNB 200 to the UE 100.

In step S108, the UE 100 transitions from the RRC inactive state to the RRC connected state.

In step S109, the UE 100 in the RRC connected state receives the multicast session #1 on the MTCH.

As described above, according to the first operation pattern, even when the resume condition is satisfied, the UE 100 in the RRC inactive state upon performing multicast reception can maintain the RRC inactive state without initiating the RRC connection resume, when, for example, the UE 100 is camping on the serving cell constituting the SFN or the serving cell to which the common PTM configuration is applied. This makes it easy to keep the UE 100 from performing unnecessary RRC connection resume.

Alternatively, as a variation of the first operation pattern, the UE 100 may evaluate whether the resume condition is satisfied regardless of whether the area condition is satisfied. The UE 100 may perform evaluation using a first reception quality threshold as the resume condition in the area in which the RRC connection resume based on the resume condition is permitted. The UE 100 may perform evaluation using a second reception quality threshold lower than the first reception quality threshold as the resume condition in an area other than the permitted area. That is, the UE 100 may change the threshold defining the resume condition according to the area (serving cell) in which the UE 100 itself is located. Accordingly, for example, when, for example, the UE 100 is camping on the serving cell constituting the SFN or the serving cell to which the common PTM configuration is applied, the resume condition is less likely to be satisfied, and the RRC inactive state is more likely to be maintained. This makes it easy to keep the UE 100 from performing unnecessary RRC connection resume.

### (3.2) Second Operation Pattern

According to the embodiment, a second operation pattern is described focusing on differences from the above-described operation pattern. The second operation pattern has the problem same as and/or similar to the first operation pattern, but has a different operation from the first operation pattern.

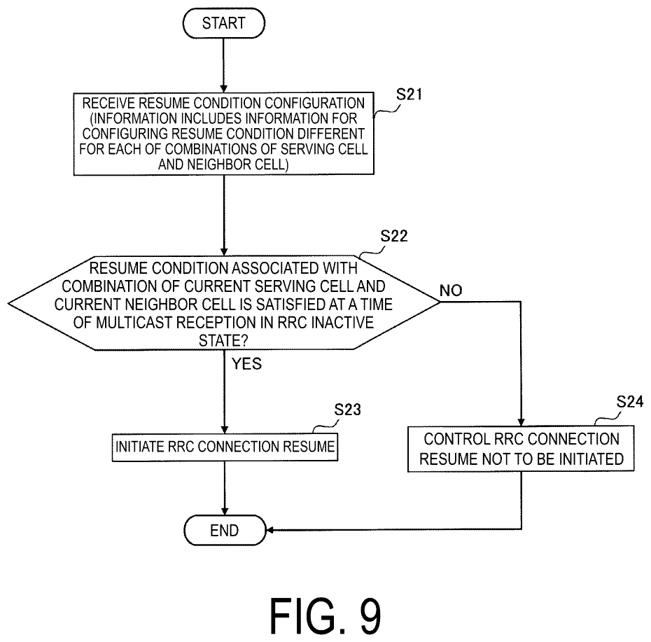

FIG. 9 is a flowchart illustrating an example of an operation of the UE 100 for the second operation pattern according to the embodiment.

In step S21, the UE 100 receives, from the network 5, information for configuring a resume condition for initiating the RRC connection resume at a time of multicast reception in the RRC inactive state, the resume condition being related to multicast reception quality. The information includes information for configuring, as the resume condition, a resume condition different (e.g., a reception quality threshold different) for each of combinations of the serving cell and the neighbor cell.

In step S22, the UE 100 determines whether the resume condition associated with a combination of a current serving cell and a current neighbor cell is satisfied at a time of multicast reception in the RRC inactive state.

If a determination is made that the resume condition associated with the combination of the current serving cell and the current neighbor cell is satisfied (step S22: YES), in step S23, the UE 100 initiates the RRC connection resume.

On the other hand, if a determination is made that the resume condition associated with the combination of the current serving cell and the current neighbor cell is not satisfied (step S22: NO), in step S24, the UE 100 controls the RRC connection resume not to be initiated.

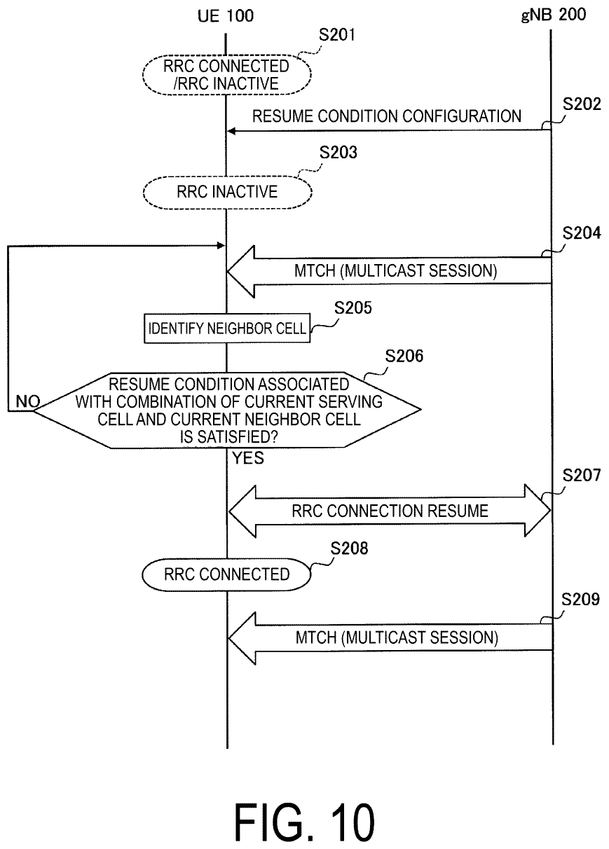

FIG. 10 is a diagram illustrating an example of an operation of the mobile communication system 1 for the second operation pattern according to the embodiment.

In step S201, the UE 100 is in the RRC connected state or the RRC inactive state in the cell (serving cell) of the gNB 200.

In step S202, the gNB 200 transmits a resume condition configuration for configuring the resume condition to the UE 100. The UE 100 receives the resume condition configuration from the gNB 200.

The gNB 200 may transmit the resume condition configuration in dedicated signaling, for example, an RRC Release message or an RRC Reconfiguration message, to the UE 100 in the RRC connected state. The gNB 200 may transmit the resume condition configuration in broadcast signaling, for example, an MCCH or an SIB, to the UE 100 in the RRC connected state or the RRC inactive state.

The resume condition configuration is, for example, information indicating the reception quality threshold (e.g., RSRP threshold and/or RSRP threshold, or the like) for the serving cell. The resume condition configuration includes information for configuring, as the resume condition, a resume condition different (e.g., a reception quality threshold different) for each of combinations of the serving cell and the neighbor cell. That is, the gNB 200 configures the UE 100 with the resume condition different for each combination of cells.

For example, the resume condition configuration includes cell information indicating a combination of cells and a resume condition (reception quality threshold) associated with the cell information. The cell information may be a combination of cell IDs, for example, a combination of a cell ID #1 and a cell ID #2. Alternatively, the cell information may be a cell ID of the neighbor cell. In this case, the UE 100 identifies the current serving cell and the cell ID (the cell ID of the neighbor cell) as a combination of cells. For example, the resume condition configuration may further include a resume condition not associated with the cell information (reception quality threshold. A reference threshold described later may be used).

In this operation pattern, the gNB 200 configures a threshold different for each cell combination, the threshold being an identical reception quality indicator. For example, the gNB 200 configures a different RSRP threshold for each cell combination. In this case, an offset value relative to a reference threshold (reference) serving as a reference may be configured for each of combinations of cells. Alternatively, the gNB 200 may configure a different reception quality indicator for each cell combination. For example, an RSRP threshold may be configured for a cell combination #1, and a block error rate (BLER) threshold may be configured for a cell combination #2.

In steps S203 and S204, the UE 100 in the RRC inactive state receives the multicast session #1 on the MTCH from the gNB 200 based on the PTM configuration provided on the MCCH by the gNB 200. The UE 100 may receive the multicast session #1 on the MTCH from the gNB 200 based on the PTM configuration provided in the RRC Release message.

In step S205, the UE 100 in the RRC inactive state identified a neighbor cell based on a received reference signal (SSB). For example, the UE 100 identifies the neighbor cell with the best reception quality.

In step S206, the UE 100 in the RRC inactive state determines whether the resume condition associated with the combination of the current serving cell and the current neighbor cell (the neighbor cell identified in step S205) is satisfied. To be more specific, the UE 100 identifies, from among the resume condition configurations, the reception quality threshold associated with the cell information that matches the combination of the current serving cell and the current neighbor cell, and determines whether the reception quality from the current serving cell falls below the identified reception quality threshold.

If the resume condition is determined to be satisfied (step S206: YES), that is, if it is determined that the reception quality from the current serving cell falls below the reception quality threshold, the UE 100 in the RRC inactive state performs RRC connection resume with the gNB 200 in step S207.

In step S208, the UE 100 transitions from the RRC inactive state to the RRC connected state.

In step S209, the UE 100 in the RRC connected state receives the multicast session #1 on the MTCH.

Note that, in this operation pattern, the example in which the combination of cells is a combination of a serving cell and a neighbor cell is described, but the combination of cells may be a combination of neighbor cells. For example, the resume condition may be configured for a combination of a neighbor cell #1 having the highest reception quality and a neighbor cell #2 having the second highest reception quality.

As described above, according to the second operation pattern, the UE 100 in the RRC inactive state upon performing multicast reception can apply the resume condition suitable for the combination of the current serving cell and the current neighbor cell. Therefore, for example, in a case of a combination of cells constituting an SFN or a combination of cells to which a common PTM configuration is applied, the reception quality threshold can be configured to be low, and the resume condition is less likely to be satisfied and the RRC inactive state is more likely to be maintained. This makes it easy to keep the UE 100 from performing unnecessary RRC connection resume.

Alternatively, as a variation of the second operation pattern, the gNB 200 may configure whether the RRC connection resume based on the resume condition is allowed for each combination with a cell. For example, the gNB 200 may configure the UE 100 such that the RRC connection resume based on the resume condition is permitted for the cell combination #1 and the RRC connection resume based on the resume condition is prohibited for the cell combination #2. The UE 100 may evaluate whether the resume condition is satisfied only in a case where the combination of the current serving cell and the current neighbor cell is a combination of cells for which the RRC connection resume based on the resume condition is permitted.

### (3.3) Third Operation Pattern

According to the embodiment, a third operation pattern is described focusing on differences from the above-described operation patterns.

In the first and second operation patterns described above, the operation is described for solving the problem in the case where the reception quality indicator compared with the reception quality threshold as the resume condition is the reception quality of the single cell (serving cell). However, since the UE 100 in the RRC inactive state may receive the MTCH (multicast session) from both the serving cell and the neighbor cell, it is desirable to use the reception quality indicator reflecting the reception states of both the serving cell and the neighbor cell.

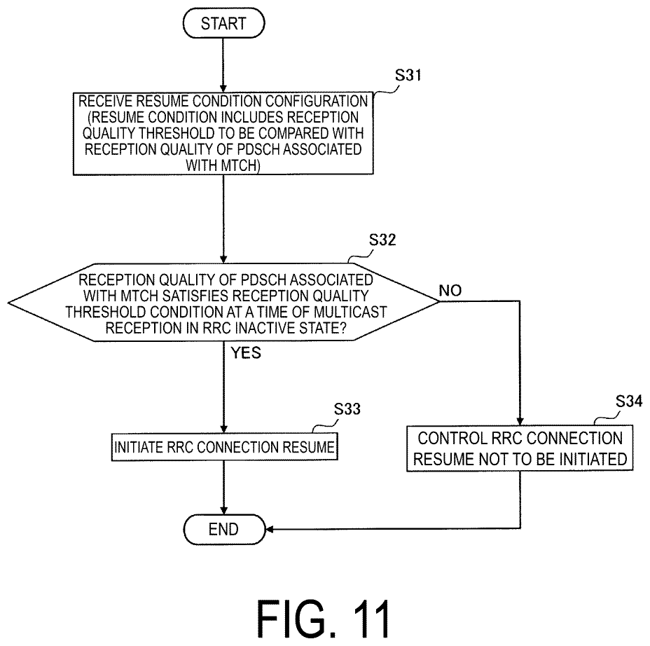

FIG. 11 is a flowchart illustrating an example of an operation of the UE 100 for the third operation pattern according to the embodiment.

In step S31, the UE 100 receives, from the network 5, information for configuring a resume condition for initiating the RRC connection resume at a time of multicast reception in the RRC inactive state, the resume condition being related to multicast reception quality. In the third operation pattern, the resume condition includes a reception quality threshold to be compared with the reception quality of the physical downlink shared channel (PDSCH) associated with the MTCH. Here, the reception quality of the PDSCH associated with the MTCH in the multicast reception is a reception quality indicator reflecting the reception states of both the serving cell and the neighbor cell, and is also referred to as multicast data reception quality.

In step S32, the UE 100 determines whether the multicast data reception quality satisfies the resume condition (the condition of the reception quality threshold) at a time of multicast reception in the RRC inactive state.

If a determination is made that the multicast data reception quality satisfies the resume condition (step S32: YES), in step S33, the UE 100 initiates the RRC connection resume.

On the other hand, if a determination is made the multicast data reception quality does not satisfy the resume condition (step S32: NO), in step S34, the UE 100 controls the RRC connection resume not to be initiated.

The multicast data reception quality may be an error rate of the multicast data, for example, a bit error rate (BER), a block error rate (BLER), or a packet error rate (PER). In a case of using such a data error rate as a reception quality indicator, the multicast data reception quality (BER/BLER/PER) satisfying the resume condition (threshold condition) may mean that the error rate is higher than the threshold, that is, the BER/BLER/PER exceeds the threshold.

The multicast data reception quality may be reception quality (RSRP/RSRQ/SINR) of a PDSCH carrying an MTCH. For example, the multicast data reception quality may be reception quality of a channel state information reference signal (CSI-RS), a tracking reference signal (TRS), or a demodulation reference signal (DMRS) transmitted in a time-frequency resource of a PDSCH carrying an MTCH. In this case, the reference signal (reference signal resource) to be measured for the UE 100 may be configured from the gNB 200 for the UE 100.

Note that the reception quality threshold to be compared with the multicast data reception quality may be configured in association with the MBS session ID or the G-RNTI from the gNB 200 for the UE 100. The UE 100 may measure the multicast data reception quality and compare a measured result with a threshold for each MBS session ID or each G-RNTI.

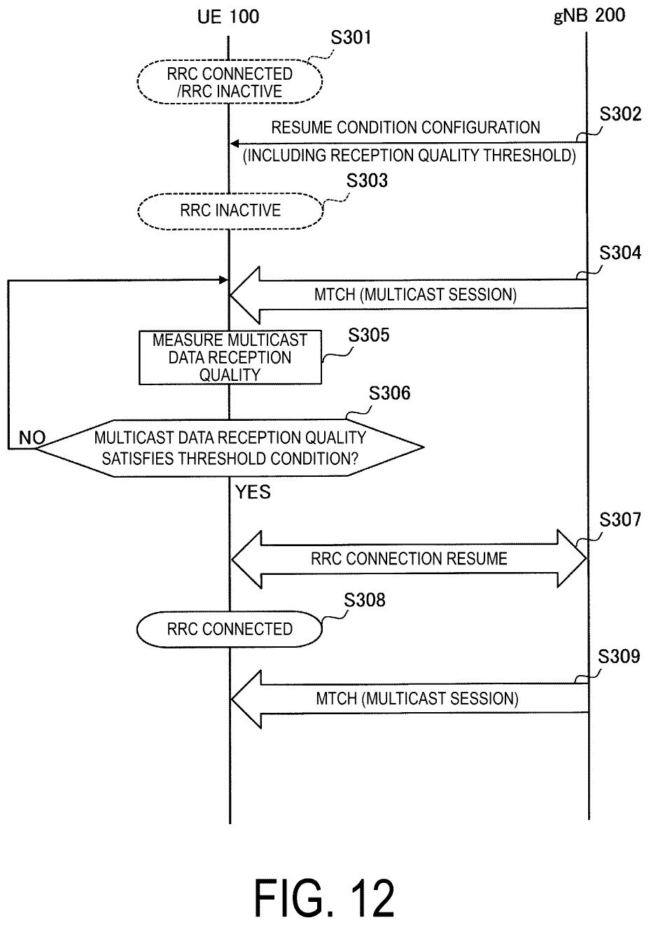

FIG. 12 is a diagram illustrating an example of an operation of the mobile communication system 1 for the third operation pattern according to the embodiment.

In step S301, the UE 100 is in the RRC connected state or the RRC inactive state in the cell (serving cell) of the gNB 200.

In step S302, the gNB 200 transmits a resume condition configuration for configuring the resume condition to the UE 100. The UE 100 receives the resume condition configuration from the gNB 200.

The gNB 200 may transmit the resume condition configuration in dedicated signaling, for example, an RRC Release message or an RRC Reconfiguration message, to the UE 100 in the RRC connected state. The gNB 200 may transmit the resume condition configuration in broadcast signaling, for example, an MCCH or an SIB, to the UE 100 in the RRC connected state or the RRC inactive state.

In the third operation pattern, the resume condition configuration includes a reception quality threshold to be compared with the multicast data reception quality. The resume condition configuration may include an MBS session ID (or G-RNTI) and a reception quality threshold associated with the MBS session ID (or G-RNTI).

In steps S303 and S304, the UE 100 in the RRC inactive state receives the multicast session #1 on the MTCH from the gNB 200 based on the PTM configuration provided on the MCCH by the gNB 200. The UE 100 may receive the multicast session #1 on the MTCH from the gNB 200 based on the PTM configuration provided in the RRC Release message.

In step S305, the UE 100 in the RRC inactive state measures a multicast data reception quality.

In step S306, the UE 100 in the RRC inactive state determines whether the multicast data reception quality satisfies the resume condition (threshold condition).

If a determination is made that the multicast data reception quality satisfies the resume condition (step S306: YES), in step S307, the UE 100 in the RRC inactive state performs the RRC connection resume with the gNB 200.

In step S308, the UE 100 transitions from the RRC inactive state to the RRC connected state.

In step S309, the UE 100 in the RRC connected state receives the multicast session #1 on the MTCH.

### (3.4) Fourth Operation Pattern

According to the embodiment, a fourth operation pattern is described focusing on differences from the above-described operation patterns.

From the viewpoint of reducing the load required for multicast reception, it is preferable that the UE 100 in the RRC inactive state continues multicast reception. Therefore, when the resume condition is not satisfied, the UE 100 configured with the resume condition may be prohibited from initiating the RRC connection resume for the multicast reception. On the other hand, when the gNB 200 does not configure the resume condition for the UE 100, the UE 100 can initiate the RRC connection resume at any time.

Alternatively, when the gNB 200 does not configure the resume condition for the UE 100, the gNB 200 may be considered not to permit the RRC connection resume to be initiated for multicast reception. In this case, in the case that the gNB 200 does not configure the resume condition for the UE 100, the UE 100 may be prohibited from initiating the RRC connection resume for multicast reception.

In the fourth operation pattern, the UE 100 determines whether the UE 100 is configured, from the network 5, with the resume condition for initiating the RRC connection resume at a time of multicast reception in the RRC inactive state, the resume condition being related to multicast reception quality. Based on the result of the determination, the UE 100 considers that the RRC connection resume for the multicast reception is prohibited from being initiated at a time of multicast reception in the RRC inactive state.

In an example of the fourth operation pattern, when the resume condition is configured for UE 100 and the resume condition is not satisfied, the UE 100 considers that the RRC connection resume for multicast reception is prohibited from being initiated.

In another example of the fourth operation pattern, when the resume condition is not configured for the UE 100, the UE 100 considers that the RRC connection resume for multicast reception is prohibited from being initiated.

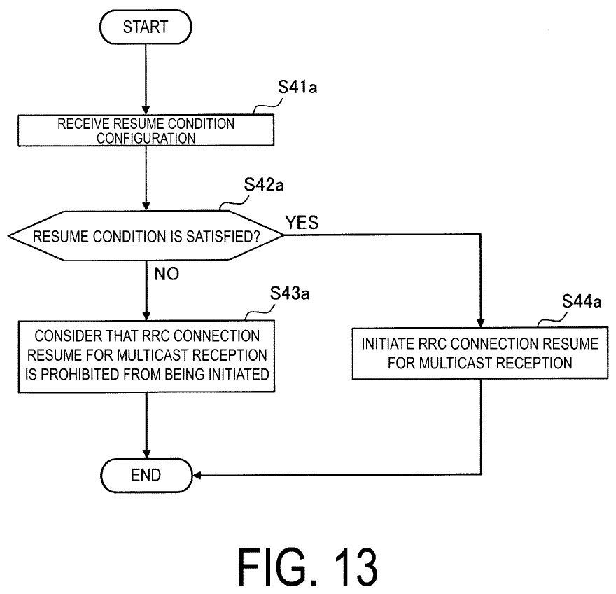

FIG. 13 is a flowchart illustrating an example of an operation of the UE 100 for the fourth operation pattern according to the embodiment.

In step S41a, the UE 100 receives the resume condition configuration from the network 5.

In step S42a, the UE 100 in the RRC inactive state upon performing multicast reception determines whether the resume condition is satisfied.

If a determination is made that the resume condition is not satisfied (step S42a: NO), in step S43a, the UE 100 considers that the RRC connection resume for multicast reception is prohibited from being initiated. In this case, the UE 100 controls the RRC connection resume for multicast reception not to be initiated. Note that in the UE 100, the AS may notify the NAS of the prohibited state (and/or the permitted state after that).

However, for a reason different from multicast reception, for example, paging reception or uplink data occurrence, the UE 100 may consider that the RRC connection resume is permitted to be initiated, and may initiate the RRC connection resume.

On the other hand, if a determination is made that the resume condition is satisfied (step S42a: YES), in step S44a, the UE 100 initiates the RRC connection resume.

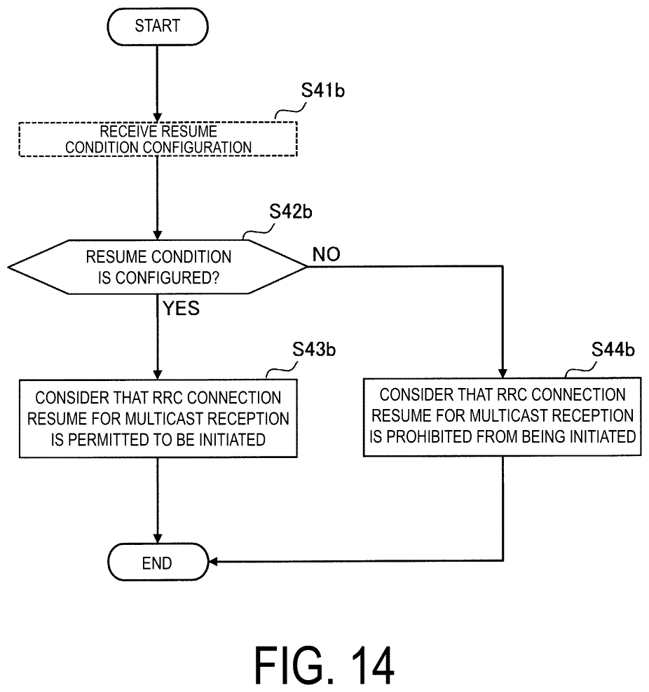

FIG. 14 is a flowchart illustrating another example of the operation of the UE 100 for the fourth operation pattern according to the embodiment.

In step S41b, the UE 100 may receive the resume condition configuration from the network 5.

In step S42b, the UE 100 in the RRC inactive state upon performing multicast reception determines whether the resume condition is configured.

If a determination is made that the resume condition is configured (step S42b: YES), in step S43b, the UE 100 considers that the RRC connection resume for multicast reception is permitted to be initiated. In this case, the UE 100 initiates the RRC connection resume for multicast reception when the resume condition is configured.

If a determination is made that the resume condition is not configured (step S42b: NO), in step S44b, UE 100 considers that the RRC connection resume for multicast reception is prohibited from being initiated. In this case, the UE 100 controls the RRC connection resume for multicast reception not to be initiated. Note that in the UE 100, the AS may notify the NAS of the prohibited state (and/or the permitted state after that).

However, for a reason different from multicast reception, for example, paging reception or uplink data occurrence, the UE 100 may consider that the RRC connection resume is permitted to be initiated, and may initiate the RRC connection resume.

Note that in step S44b, when the UE 100 has a valid PTM configuration for the RRC inactive state (and/or the MCCH of the neighbor cell includes the PTM configuration of the MBS session ID in which the UE is interested) and that the resume condition is not configured, the UE may consider that the RRC connection resume for multicast reception is prohibited from being initiated.

### (3.5) Fifth Operation Pattern

According to the embodiment, a fifth operation pattern is described focusing on differences from the above-described operation patterns.

When the UE 100 in the RRC inactive state upon performing multicast reception initiates the RRC connection resume in response to the resume condition being satisfied, the UE 100 transmits an RRC Resume Request message to the gNB 200 (current serving cell). Here, the gNB 200 ordinarily receives the RRC Resume Request message and transmits an RRC Resume message to the UE 100.

However, for example, in congestion of the gNB 200, the gNB 200 may reject the RRC Resume Request message and transmit an RRC Release message or an RRC Reject message to the UE 100.

The UE 100 in the RRC inactive state upon receiving a multicast session performing the RRC resume in response to the resume condition being satisfied means that the QoS request of the multicast session cannot be satisfied. Therefore, in order to satisfy the QoS request, it is desirable to cause such a UE 100 to transition to the RRC connected state with the highest priority and continue the reception of the multicast session in the RRC connected state.

The fifth operation pattern is an operation pattern to make it easy to satisfy the QoS request for the multicast session.

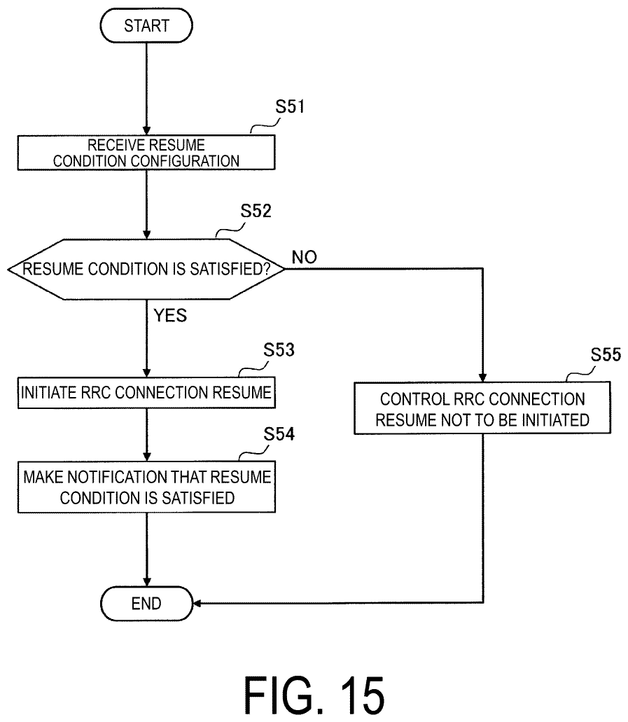

FIG. 15 is a flowchart illustrating an example of an operation of the UE 100 for the fifth operation pattern according to the embodiment.

In step S51, the UE 100 receives, from the network 5, information for configuring a resume condition for initiating the RRC connection resume at a time of multicast reception in the RRC inactive state, the resume condition being related to multicast reception quality.

In step S52, the UE 100 determines whether the resume condition is satisfied at a time of multicast reception in the RRC inactive state.

If a determination is made that the resume condition is satisfied (step S52: YES), in step S53, the UE 100 initiates the RRC connection resume. In this operation pattern, the UE 100 notifies the network 5 that the resume condition is satisfied during the procedure of the RRC connection resume. For example, the UE 100 transmits an RRC Resume Request message including an information element indicating that the resume condition is satisfied to the network 5. Alternatively, the UE 100 may make that notification by transmitting a random access preamble to the network 5 using a physical random access channel (PRACH) resource indicating that the resume condition is satisfied. In this case, assume that the UE 100 is notified in advance of the PRACH resource indicating that the resume condition is satisfied from the gNB 200.

On the other hand, if a determination is made that the multicast data reception quality does not satisfy the resume condition (step S52: NO), in step S55, the UE 100 controls the RRC connection resume not to be initiated.

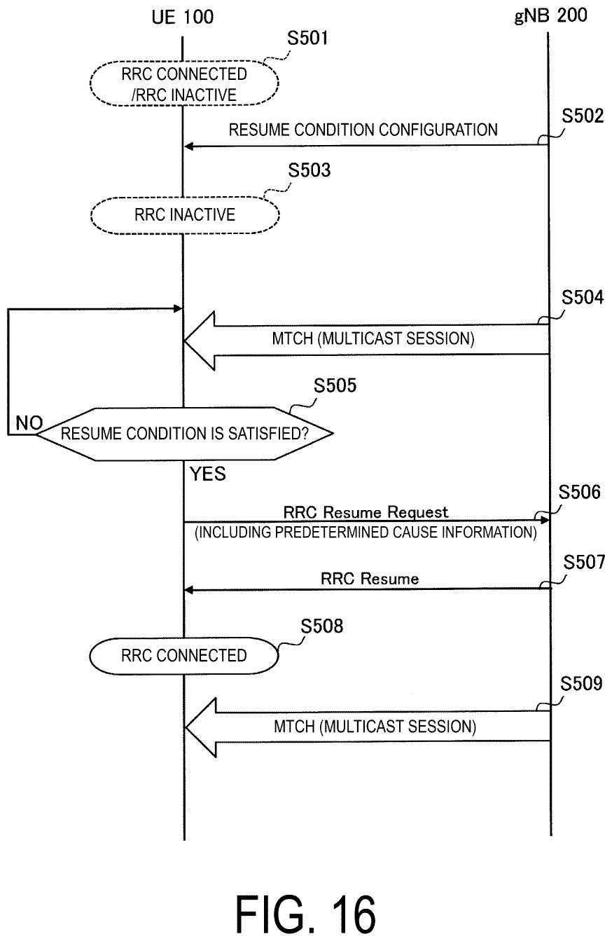

FIG. 16 is a diagram illustrating an example of an operation of the mobile communication system 1 for the fifth operation pattern according to the embodiment. Here, a case where the notification is made in the RRC Resume Request message is described.

The operations from step S501 to step S505 are the same as and/or similar to those of the above-described operation patterns.

If a determination is made that the resume condition is satisfied (step S505: YES), the UE 100 in the RRC inactive state initiates the procedure of RRC connection resume. Note that the UE 100 may recognize that the multicast reception in the RRC connected state is required. The UE 100 may recognize that a new PTM configuration is required. The UE 100 may recognize that the QoS request of the multicast session will no longer be satisfied.

In step S506, the UE 100 transmits an RRC Resume Request message to the gNB 200. Here, the UE 100 sets a cause value corresponding to multicast session reception quality degradation in Resume Cause, which is a field in the RRC Resume Request message. The value (cause value) is, for example, a value corresponding to “multicast reception quality degradation”, “multicast PTM configuration update”, “multicast reception in an RRC connected state is required” or the like. The value (cause value) may be a value corresponding to a reception quality indicator satisfying the resume condition, for example, “multicast RSRP becomes worse than a threshold”, “multicast BLER becomes worse than a threshold”, or an index value corresponding to these. Alternatively, the UE 100 may set an existing high priority cause value (e.g., emergency, mt-Access, mo-Signalling).

The gNB 200, when receiving the RRC Resume Request message, recognizes that the multicast session reception quality of the UE 100 is degraded based on the Resume Cause, and preferentially processes the RRC connection resume of the UE 100.

In step S507, the gNB 200 transmits an RRC Release message to the UE 100.

In step S508, the UE 100 transitions from the RRC inactive state to the RRC connected state.

In step S509, the UE 100 in the RRC connected state performs multicast reception on the MTCH.

Note that the gNB 200 may configure the UE 100 with the MRB for RRC connected state or the updated PTM configuration (MRB for inactive) in the RRC Resume message or after the transition of the UE 100 to the RRC connected state.

### (3.6) Sixth Operation Pattern

According to the embodiment, a sixth operation pattern is described focusing on differences from the above-described operation patterns.

In this operation pattern, a scenario is assumed in which the UE 100 in the inactive state receives a plurality of multicast sessions. In such a scenario, the network 5 (the gNB 200) configures the UE 100 with the resume condition (reception quality threshold), for each multicast session, determined according to the QoS request of the multicast session. However, the gNB 200 may not need to configure the resume condition for some multicast sessions among the plurality of multicast sessions held by the UE 100.

In this operation pattern, the UE 100 receives, from the network 5, information for configuring a plurality of resume conditions corresponding to the plurality of multicast sessions received by the UE 100. Then, the UE 100 initiates the RRC connection resume in response to at least one of the plurality of resume conditions being satisfied. This enables the RRC connection resume based on the resume condition even when the UE 100 in the inactive state receives a plurality of multicast sessions.

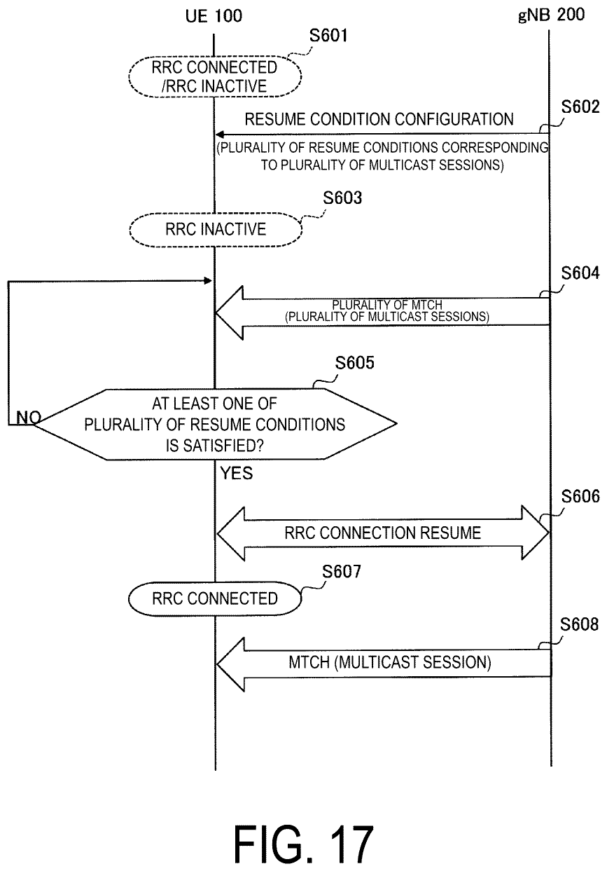

FIG. 17 is a diagram illustrating an example of an operation of the mobile communication system 1 for the sixth operation pattern according to the embodiment. Assume that the UE 100 has already joined a plurality of multicast sessions, and the gNB 200 has grasped the plurality of multicast sessions.

In step S601, the UE 100 is in the RRC connected state or the RRC inactive state in the cell (serving cell) of the gNB 200.

In step S602, the gNB 200 transmits a resume condition configuration for configuring the resume condition to the UE 100. The UE 100 receives the resume condition configuration from the gNB 200.

The gNB 200 may transmit the resume condition configuration in dedicated signaling, for example, an RRC Release message or an RRC Reconfiguration message, to the UE 100 in the RRC connected state. The gNB 200 may transmit the resume condition configuration in broadcast signaling, for example, an MCCH or an SIB, to the UE 100 in the RRC connected state or the RRC inactive state.

In the sixth operation pattern, the resume condition is configured for each session (for each MBS session ID). In the resume condition configuration, the resume condition and the MBS session ID may be associated with each other. The resume condition configuration may include a configuration for the number of resume conditions for performing the RRC resume. The UE 100 may initiate the RRC connection resume in response to the configured number (the number of resume conditions) of multicast sessions among the plurality of multicast sessions of the UE 100 itself satisfying the resume conditions.

In steps S603 and S604, the UE 100 in the RRC inactive state receives each multicast session on the corresponding MTCH from the gNB 200.

In step S605, the UE 100 in the RRC inactive state measures the reception quality of each multicast session (e.g., the multicast data reception quality), and determines whether the reception quality satisfies the corresponding resume condition.

For example, the UE 100 may initiate the RRC connection resume in response to the corresponding resume condition being satisfied for at least one multicast session, the corresponding resume condition being satisfied for each of the configured number of multicast sessions, or the corresponding resume condition being satisfied for each of all multicast sessions. Note that the UE 100 may not need to evaluate the resume condition for the multicast session for which the corresponding resume condition is not configured.

The gNB 200 may configure a prioritized multicast session for the UE 100. When the prioritized multicast session is configured and the prioritized multicast session satisfies the corresponding resume condition, the UE 100 may initiate the RRC connection resume even when the configured number of multicast sessions do not satisfy the resume conditions.

In step S606, the UE 100 in the RRC inactive state performs the RRC connection resume with the gNB 200.

In step S607, the UE 100 transitions from the RRC inactive state to the RRC connected state.

In step S608, the UE 100 in the RRC connected state receives each multicast session on the corresponding MTCH.

### (4) Other Embodiments

The resume condition may be configured in association with each of the serving cell and the neighbor cell from the gNB 200 for the UE 100. The UE 100 may perform the RRC resume only in a case where these two resume conditions are satisfied, and may not need to perform the RRC resume in other cases. For example, in a case where the threshold of the RSRP is the resume condition, when the RSRP of the serving cell falls below the threshold and the RSRP of the neighbor cell falls below the threshold, the RRC resume is performed. Note that these RSRP thresholds may be configured to have different values. Note that the combination of the two resume conditions may be a set targeted to the serving cell and all the neighbor cells, or may be configured differently for each neighbor cell.

Although the multicast reception in the RRC inactive state has been mainly described in the above-described embodiments, the operations according to the above-described embodiments may also be applied to multicast reception in the RRC idle state. With respect to the RRC idle state, the above-described RRC resume (Resume) can be read as RRC establishment (Establishment).

The operation flows described above can be separately and independently implemented, and also be implemented in combination of two or more of the operation flows. For example, some steps of one operation flow may be added to another operation flow or some steps of one operation flow may be replaced with some steps of another operation flow. In each flow, all steps may not be necessarily performed, and only some of the steps may be performed.

Although the example in which the base station is an NR base station (gNB) has been described in the embodiments and examples described above, the base station may be an LTE base station (eNB) or a 6G base station. The base station may be a relay node such as an Integrated Access and Backhaul (IAB) node. The base station may be a DU of the IAB node. The UE 100 may be a Mobile Termination (MT) of the IAB node.

That is, the UE 100 may be a terminal function unit (a type of communication module) for a base station to control a repeater that performs signal relay. Such terminal function unit is referred to as an MT. Examples of the MT include, a Network Controlled Repeater (NCR)-MT, a Reconfigurable Intelligent Surface (RIS)-MT, in addition to the IAB-MT.

The term “network node” mainly means a base station, but may also mean a core network apparatus or a part (CU, DU, or RU) of the base station. The network node may include a combination of at least a part of the apparatus of the core network and at least a part of the base station.

A program causing a computer to execute each of the processing performed by the UE 100 or the gNB 200 may be provided. The program may be recorded in a computer-readable medium. Use of the computer-readable medium enables the program to be installed on a computer. Here, the computer-readable medium on which the program is recorded may be a non-transitory recording medium. The non-transitory recording medium is not particularly limited, and may be, for example, a recording medium such as a CD-ROM or a DVD-ROM. Circuits for executing processing performed by the UE 100 or the gNB 200 may be integrated, and at least a part of the UE 100 and the gNB 200 may be implemented as a semiconductor integrated circuit (chipset, System on a chip (SoC)).

The functions achieved by the UE 100 or the gNB 200 (the network node) may be implemented in a circuitry or a processing circuitry programmed to perform the described functions, including a general-purpose processor, a special-purpose processor, an integrated circuit, application specific integrated circuits (ASICs, a central processing unit (CPU), a conventional circuit, and/or combinations thereof. The processor may include transistors and other circuits and may be considered a circuitry or a processing circuitry. The processor may be a programmed processor that executes a program stored in the memory. As used herein, a circuitry, a unit, means are hardware programmed to achieve, or hardware performing, the described functions. The hardware may be any hardware disclosed herein or any hardware programmed to achieve or known to perform the described functions. When the hardware is a processor that is considered to be a type of circuitry, the circuitry, means, or a unit is a combination of hardware and software used to configure the hardware and/or the processor.

The phrases “based on” and “depending on/in response to” used in the present disclosure do not mean “based only on” and “only depending on/in response to” unless specifically stated otherwise. The phrase “based on” means both “based only on” and “based at least in part on”. The phrase “depending on” means both “only depending on” and “at least partially depending on”. The terms “include,” “comprise” and variations thereof do not mean “include only items stated” but instead mean “may include only items stated” or “may include not only the items stated but also other items.” The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a”, “an”, and “the” are added in the present disclosure through translation, these articles include the plural unless clearly indicated otherwise in context.

The embodiments have been described above in detail with reference to the drawings, but specific configurations are not limited to those described above, and various design variation can be made without departing from the gist of the present disclosure.

### (5) Supplementary Notes A

Features relating to the embodiments described above are described below as supplements.

### Supplementary Note 1

A communication method performed by a user equipment in a mobile communication system configured to provide a multicast/broadcast service (MBS), the communication method including:
receiving, from a network, information for configuring a resume condition for initiating a radio resource control (RRC) connection resume at a time of multicast reception in an RRC inactive state, the resume condition being in terms of multicast reception quality;
receiving, from the network, information for configuring an area condition for an area in which the RRC connection resume based on the resume condition is permitted or prohibited; and
initiating the RRC connection resume when the resume condition is satisfied and the area condition is satisfied at a time of multicast reception in the RRC inactive state.

### Supplementary Note 2

The communication method according to supplementary note 1, further including:
controlling the RRC connection resume based on the resume condition not to be initiated when the area condition is not satisfied even with the resume condition being configured.

### Supplementary Note 3

The communication method according to supplementary note 1 or 2, wherein
the area condition is a condition that the user equipment is not located in the area consisting of a group of cells to which a common point-to-multipoint (PTM) configuration is applied, or a condition that the user equipment is located in the area consisting of a group of cells to which the common PTM configuration is not applied.

### Supplementary Note 4

The communication method according to supplementary note 1 or 2, wherein
the area condition is a condition that the user equipment is not located in the area consisting of a group of cells constituting a single frequency network (SFN), or a condition that the user equipment is located in the area consisting of a group of cells not constituting the SFN.

### Supplementary Note 5

The communication method according to supplementary note 1 or 2, wherein
the area condition is a condition that the user equipment is located in the area consisting of a group of cells in which the RRC connection resume based on the resume condition is permitted, or a condition that the user equipment is not located in the area consisting of a group of cells in which the RRC connection resume based on the resume condition is prohibited.

### Supplementary Note 6

A communication method performed by a user equipment in a mobile communication system configured to provide a multicast/broadcast service (MBS), the communication method including:
receiving, from a network, information for configuring a resume condition for initiating a radio resource control (RRC) connection resume at a time of multicast reception in an RRC inactive state, the resume condition being related to multicast reception quality, the information including information for configuring, as the resume condition, a resume condition different for each of combinations of a serving cell and a neighbor cell; and
initiating the RRC connection resume in response to the resume condition associated with a combination of a current serving cell and a current neighbor cell being satisfied at a time of multicast reception in the RRC inactive state.

### Supplementary Note 7

A communication method performed by a user equipment in a mobile communication system configured to provide a multicast/broadcast service (MBS), the communication method including:
receiving, from a network, information for configuring a resume condition for initiating a radio resource control (RRC) connection resume at a time of multicast reception in an RRC inactive state, the resume condition being related to multicast reception quality, the resume condition including a reception quality threshold to be compared with a multicast reception quality of a physical downlink shared channel (PDSCH) associated with a multicast traffic channel (MTCH); and
initiating the RRC connection resume in response to reception quality of the PDSCH associated with the MTCH in the multicast reception satisfying a condition of the reception quality threshold at a time of multicast reception in the RRC inactive state.

### Supplementary Note 8

A communication method performed by a user equipment in a mobile communication system configured to provide a multicast/broadcast service (MBS), the communication method including:
determining whether a user equipment is configured, from a network, with a resume condition for initiating a radio resource control (RRC) connection resume at a time of multicast reception in an RRC inactive state, the resume condition being related to multicast reception quality; and considering that the RRC connection resume for the multicast reception is prohibited from being initiated at a time of multicast reception in the RRC inactive state, based on a result of the determining.

### Supplementary Note 9

The communication method according to supplementary note 8, wherein
the considering that the RRC connection resume for the multicast reception is prohibited includes considering that the RRC connection resume for the multicast reception is prohibited from being initiated when the resume condition is configured for the user equipment and the resume condition is not satisfied.

### Supplementary Note 10

The communication method according to supplementary note 8, wherein
the considering that the RRC connection resume for the multicast reception is prohibited includes considering that the RRC connection resume for the multicast reception is prohibited from being initiated when the resume condition is not configured for the user equipment.

### Supplementary Note 11

A communication method performed by a user equipment in a mobile communication system configured to provide a multicast/broadcast service (MBS), the communication method including:
receiving, from a network, information for configuring a resume condition for initiating a radio resource control (RRC) connection resume at a time of multicast reception in an RRC inactive state, the resume condition being related to multicast reception quality;
initiating the RRC connection resume in response to the resume condition being satisfied at a time of multicast reception in the RRC inactive state; and
notifying the network that the resume condition is satisfied in a procedure of the RRC connection resume.

### Supplementary Note 12

The communication method according to supplementary note 11, wherein
the notifying includes transmitting, to the network, an RRC resume request message including an information element indicating that the resume condition is satisfied.

### Supplementary Note 13

A communication method performed by a user equipment in a mobile communication system configured to provide a multicast/broadcast service (MBS), the communication method including:
receiving, from a network, information for configuring a resume condition for initiating a radio resource control (RRC) connection resume at a time of multicast reception in an RRC inactive state, the resume condition being related to multicast reception quality; and
initiating the RRC connection resume in response to the resume condition being satisfied at a time of multicast reception in the RRC inactive state,
wherein the receiving includes receiving the information for configuring a plurality of the resume conditions corresponding to a plurality of multicast sessions received by the user equipment, and
the initiating including initiating the RRC connection resume in response to at least one of the plurality of the resume conditions being satisfied.

### (6) Supplementary Notes B

### 1. Introduction

The work items for enhanced MBS (eMBS) are intended to support the multicast reception by the UE in the inactive state and described as follows.
To define support for the multicast reception by the UE in the RRC inactive state [RAN2, RAN3].
A PTM configuration for the UE that receives the multicast in the RRC inactive state [RAN2].
To investigate the impact of mobility and state transition of the UE receiving the multicast in the RRC inactive state (seamless/lossless mobility is not a requirement) [RAN2, RAN3].

RAN2 has discussed this purpose and reached a series of agreement items. Based on these agreement items, an aspect the control plane for multicast reception in the inactive state is discussed in the supplementary notes.

### 2. Discussion

### 2.1 Initial Configuration Procedure

RAN2 #120 has reached an agreement to advance the “mixed approach”.

The mixed approach is advanced as follows.
1. When the NW configures the UE to continue multicast reception in the inactive state, the NW provides the PTM configuration for the activated multicast session through RRC dedicated signaling to at least the serving cell (other cases need to be further studied).
2. The MCCH is used when the PTM configuration needs to be changed or when the PTM configuration needs to be indicated during migrating beyond the serving cell/gNB. The change of the session status and other indications need to be further studied.
3. Assume that the UE can receive the multicast service after joining the session.
4. Whether the MCCH configuration is initially provided to the UE through the dedicated signaling needs to be further studied.

RAN2 #121 agreed to the following description.
The UE needs to join the multicast session before receiving the multicast in RRC inactive.
The network may configure the UE with the PTM configuration of the (single) serving cell before the session activation when the network determines that it is useful, and the UE may store the configuration.—When the session is activated, the UE can apply the configuration to receive the multicast in the inactive state without returning to RRC connected unless updated by the MCCH after the configuration.
When the network configures the UE to receive multicast in the inactive state, the PTM configuration can be delivered using an RRC Release message including suspendconfig. No other dedicated RRC message is used to provide the PTM configuration of the MBS multicast in the inactive state.
A new MCCH logical channel for multicast in inactive (different from broadcast MCCH) is introduced.
The multicast MCCH configuration is provided via a new SIB.
Optionally, the multicast MCCH configuration for the serving cell can also be provided in dedicated signaling. Therefore, optimization is not performed for the mobility.

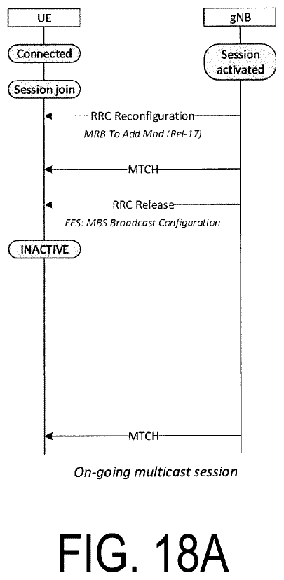

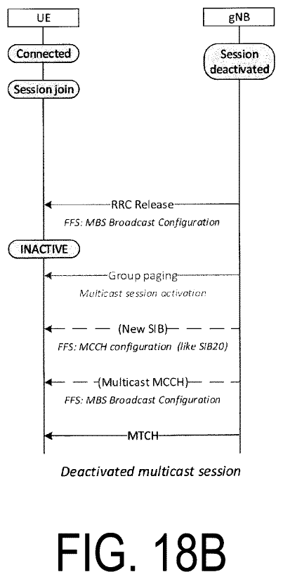

Based on these agreement items, the configuration procedure for an ongoing (i.e., activated) multicast session and a deactivated (i.e., before being activated) multicast session can be considered as in FIG. 18A and FIG. 18B.

### 2.1.1. Ongoing (Active) Multicast Session

For an ongoing multicast session, the UE configures a multicast MRB for multicast reception in connected by the RRC reconfiguration and starts receiving the MTCH as in Rel-1. For multicast reception in inactive, the UE configures a broadcast MRB for multicast reception (or a new “multicast inactive MRB”) via RRC release.

It is clear that the PTM configuration for RRC Resume has the same content (e.g., IE) as the Rel-17 MCCH (MBSBroadcastConfiguration) as a baseline. However, since RAN2 agreed on “introduction of a new MCCH logical channel”, the RRC message name also needs to be different from Rel-17 MBSBroadcastConfiguration. The same message is transferred via the new MCCH logical channel.

Proposal 1: RAN2 should agree to define a new RRC message for PTM configuration in the RRC release and to define a new “multicast MCCH”, e.g. MBSMulticastInactiveConfiguration.

Proposal 2: RAN2 should agree that the IE of the new RRC message for PTM configuration is the same as Rel-17 MBSBroadcastConfiguration as a baseline.

When the UE receives RRCRelease with suspendConfig as in Rel-1, the connected multicast MRB is suspended. The UE continues the same multicast session when the RRC release includes the PTM configuration in the inactive state. During/after the RRC state transition, service continuity of the multicast session needs to be ensured. This is similar to legacy dedicated configuration such as redirectedCarrierInfo, cellReselectionPriorities, deprioritisationReq, and measIdleConfig. The UE needs to start receiving the broadcast MRB as soon as applying the PTM configuration. Further study is needed as to whether a new procedure (i.e., the UE applies the PTM configuration and starts receiving the MTCH) is performed when the UE applies the suspendConfig.

Proposal 3: RAN2 should agree that before suspending the multicast MRB, the UE applies the PTM configuration of the broadcast MRB (or a new “multicast inactive MRB”) and starts receiving the corresponding MCCH.

### 2.1.2. Deactivated (Before Activated) Multicast Session

For a deactivated multicast session, the UE performs PTM configuration by the RRC release. In a case where the above proposal 3 can be agreed, the UE will immediately start receiving the MTCH, but since the MTCH is not transmitted at this time, the UE should refrain from this. Instead, the UE needs to be notified that the multicast session is still inactive via the RRC release so that the UE can wait for the multicast session activation notification without performing MTCH reception. Further study is needed as to the detailed operation, for example, whether to wait for the activation of the session while applying the PTM configuration can be decided.

Proposal 4: RAN2 should agree to notify the UE by RRC release whether the multicast session has been deactivated, so that the UE does not attempt to receive the corresponding MTCH.

After transitioning to inactive, the UE monitors a multicast session activation notification (i.e., group paging). Before the multicast session activation, the gNB may change the PTM configuration of the session, such change being configured by the new “multicast MCCH” of the UE in inactive. In this case, the gNB can transmit the “multicast MCCH” before the session activation.

From the perspective of the UE, when the UE needs to monitor a new “multicast MCCH” of the deactivated multicast session, power consumption of the UE increases. Therefore, the UE needs to confirm that the UE does not need to monitor the multicast MCCH before receiving the multicast session activation notification. In other words, the UE may only monitor the multicast MCCH upon receiving the activation notification with the TMGI of interest. The same operation can be applied to a new SIB (such as SIB20) for MCCH configuration.

Proposal 5: RAN2 should agree that the UE does not need to monitor a new “multicast MCCH” or a new SIB (such as SIB20) when the corresponding multicast session is deactivated (i.e., before receiving the multicast session notification).

Upon receiving the multicast activation notification, the UE needs to check whether the MCCH configuration in the new SIB and/or the PTM configuration in the multicast MCCH has been updated in a case where the MCCH configuration and/or the PTM configuration is provided from the RRC release. As long as the configuration is not updated, the stored configuration, i.e. the configuration provided by the RRC release, should be applied. Of course, in a case where the configuration is updated, the UE needs to acquire a new SIB and/or multicast MCCH.

For a new SIB, it is expected that the UE can know whether the new SIB has been updated by checking a value tag of the SIB1 as in the current situation. On the other hand, the UE does not know whether the multicast MCCH has been updated before receiving and decoding the MCCH. In this case, even in a case configured by the RRC release, the UE needs to decode the MCCH once anyway, which is also meaningless similarly. In this sense, in order for the UE to know the update of the PTM configuration without decoding the MCCH, the value tag needs to be introduced in the MCCH. Where the value tag of the MCCH is located, whether the value tag is located in a new SIB, a SIB1, or a group paging, etc., needs to be further studied.

Proposal 6: RAN2 should agree that an MCCH value tag is introduced that the UE uses to know whether the PTM configuration has been updated from that configured by the RRC release, without decoding the MCCH itself.

### 2.2. Update of Configuration in Inactive

In Rel-17, there exists one MCCH in a cell. In Rel-18, RAN2 agreed on “introduction of a new MCCH logical channel for multicast in inactive (different from broadcast MCCH)”. A multicast “MCCH is used when the PTM configuration needs to be changed or when the PTM configuration needs to be indicated during migrating beyond the serving cell/gNB.

Observation 1: A multicast MCCH is used to update the PTM configuration of the UE in inactive.

That is, in the Rel-18 network, there exist two MCCHs of a (broadcast) MCCH and a multicast MCCH. The motivation for introducing separate MCCHs in a cell may be to handle different service requirements of different cast types (MBS broadcast and MBS multicast).

The question is whether different multicast sessions also have different service requirements. The service requirements of the group multimedia call service and the firmware download service are considered to be quite different. For example, because the group multimedia call service is a foreground service, the PTM configuration needs to be frequently optimized, but because the firmware download service is a background service, such frequent optimization is not needed. Considering that the initial PTM configuration is provided by the RRC release, updating of the PTM configuration by multicast MCCH is needed for some services but not for other services. In this sense, introducing a plurality of multicast MCCHs is efficient for the UE and flexible for the network.

Proposal 7: RAN2 should discuss whether to introduce a plurality of multicast MCCHs per cell.

### 2.3. UE Mobility and Service Continuity

### 2.3.1. Prioritization of Frequencies

RAN2 #121bis-e agreed that further study is needed as to the operation of the UE upon cell reselection.
Similar to the Rel-17 broadcast reception procedure, the UE acquires a new SIB and multicast MCCH after the cell reselection and acquires PTM configuration.
In a case where the UE reselects a cell where no PTM configuration is available on the multicast MCCH, the UE initiates an RRC resume procedure for the active multicast session that is interested in receiving or continuing to receive.
Prioritization of frequencies may be provided to the UE for the cell reselection for multicast reception in the RRC inactive, but further study is needed as to the detailed mechanism for how to identify frequency information (e.g., SAI, USD, or frequency information provided directly from the network).
There is no need to define a mechanism other than the prioritization of frequencies, i.e., prioritization per cell in the cell reselection, so that the UE can select a suitable cell.
The neighbor cell list mechanism for multicast reception in the RRC inactive can be configured to be used by the UE to resume the RRC connection when no service is available in the reselected cell by the NCL without reading the MCCH in the reselected cell in some aspects similar to the Rel-17 NCL mechanism in MBS broadcast.

For frequency information, higher layers can provide the information, such as via the USD. However, considering that the NRMBS transmission is decided on a cell-by-cell basis, the RAN also needs to provide frequency information if possible, since the USD can only provide static information (especially for UE in inactive), while the RAN may have up-to-date information. Therefore, as in the SIB21 of Rel-17 MBS broadcast, the gNB can broadcast frequency information so that the UE can prioritize the appropriate frequency upon cell reselection.

Proposal 8: RAN2 should agree that the frequency information is broadcast by the gNB.

### 2.3.2 Area-specific PTM Configuration

In RAN2 #121, the area scope of the MCCH was discussed. Some companies propose to enhance the service continuity during the UE migration by enabling the PTM configuration in a plurality of cells. The PTM configurations for the respective cells can be easily matched (if necessary) for the intra-gNB, but difficult for the inter-gNB and negotiation with the Xn-AP is required. Finally, RAN2 agrees that the area scope does not involve other gNBs, and further study is needed for the intra-gNB.
The serving cell does not provide the PTM configuration of the neighbor cell from other gNBs.
Further study is needed as to whether the network can provide the PTM configuration to the intra-gNB cell.

This small function enhancement is considered no problem even if limited to the intra-gNB. Therefore, RAN2 needs to discuss whether the PTM configuration can be applied to a plurality of intra-gNB cells.

Proposal 9: RAN2 should discuss whether the PTM configuration can be applied to a plurality of intra-gNB cells.

### 2.3.3. QoS Enforcement

RAN2 #119e has reached the following agreement items relating to case 3.
HARQ feedback and PTP are not supported in the multicast reception in the RRC inactive.

According to the agreement items, the multicast reception in the inactive is the same as and/or similar to the MBS broadcast reception defined in Rel-17 (so-called delivery mode 2). The MBS broadcast is of the best-effort type.

On the other hand, ensuring QoS/reliability is an important issue for the multicast session. SA2 has also questioned whether there exists a difference in the qualities/reliabilities of multicast reception between the connected state and the inactive state, and RAN2 #119bis-e agreed on the following answers.

RAN2 Q1-a) in a case where there exists a large difference in the qualities/reliabilities of MBS data reception between the UE in the RRC connected state and the UE in the RRC inactive state, the qualities and the reliabilities of the MBS data reception between the UE in the RRC connected state and the UE in the RRC inactive state may be different because HARQ feedback and PTP transmission are not supported, and seamless/lossless mobility is not required for multicast reception in the RRC inactive state.

RAN2 #121bis-e agreed to introduce an event-triggered RRC resume mechanism, but further study is needed as to the trigger condition.

When the reception quality of the multicast data falls below a configured threshold, the UE may trigger the resume of the RRC connection.

RAN2 #119e has proposed to introduce threshold values for reception qualities such as RSRP and BLER, and the threshold values are considered to be used to ensure a certain level of QoS required for multicast reception.

As for the threshold for the RSRP, since the NR MBS assumes a single-cell transmission method, the MTCH in not directly monitored, and the SSB or the CSI-RS is monitored, the UE is considered to be required to always transition to the connected state every time the UE moves to a cell edge or performs the cell reselection. This operation may not be an optimal operation in some deployments from the viewpoint of the network congestion and the power saving of the UE. However, the RSRP is one of the basic metrics for evaluating the reception quality, and is one of the usual metrics when the gNB decides a handover (i.e., the handover is performed after the UE transitions to connected due to this RSRP threshold).

The threshold for a BLER is considered to be easy to understand to directly monitor the quality of the MTCH and ensure the QoS requirements. Therefore, the BLER is worth designating to the metrics.

Another way is to define specific events. For example, when an event is configured for the cell reselection, the UE always has to transition to the connected before the cell reselection. However, such an event can be emulated by the RSRP threshold described above. Therefore, when the RAN2 defines an event that is a trigger condition, careful consideration is required.

In summary, at least the RSRP threshold and/or the MTCH BLER threshold should be used for event-triggered RRC resume.

Proposal 10: RAN2 should agree to introduce RSRP threshold and/or MTCH BLER threshold to monitor the multicast reception quality and trigger the RRC resume.

### 2.4. Notifications

### 2.4.1. Deactivation of Multicast Session

In RAN2 #121bis-e, a method of notifying the UE of the session deactivation is discussed.
Further study is needed as to which option of group paging enhancement or MCCH enhancement to take in order to allow Rel-18 UEs to remain in the RRC inactive and stop monitoring the corresponding G-RNTI during a session deactivation/temporary no-data event.

In the above agreement items, only enhanced group paging or enhanced MCCH can be confirmed, but the new MAC CE is not explicitly excluded. Only the key points of the analysis of these options are summarized in Table 1.

TABLE 1

| | Group paging | | |
|---|---|---|---|
| | enhancement | Enhanced MCCH | New MAC CE |
| Legacy baseline | Unusable | Available in LTE MBMS | Available in LTE |
| mechanisms | | (Assuming that PTM | SC-PTM |
| | | configuration is deleted when | (SC-PTM stop |
| | | session is disabled) | indication MAC |
| | | Unavailable | CE) |
| | | (Assuming that deactivation | |
| | | indication is introduced) | |
| Logical channel | PCCH | MCCH | MTCH |
| Delay after stopping | Middle | Long | Short |
| MTCH | | | |
| Additional UE activity | Nothing | Nothing | Nothing |
| (other than MTCH | UE needs to always | UE needs to always monitor | UE has received |
| reception) | monitor PO | MCCH | MTCH |

Among the three options, the MAC CE is considered to be the most efficient in terms of UE power consumption (i.e., due to the shortest delay). However, as a result of discussion by electronic mail, there exist few consenters to this option.

Among the two possible options, the enhanced group paging is slightly more advantageous also in terms of UE power consumption. Based on legacy operation, the MCCH needs to delete the PTM configuration of the deactivated session. Considering that this multicast session is active again (since it has not been released), the enhanced MCCH needs to add the same PTM configuration again, and the UE needs to re-acquire and apply this configuration. What is enhanced with the enhanced MCCH is not clear. Assuming that a deactivation notification is added to the MCCH (same and/or similar notification is added in the enhanced group paging), this notification is delayed so that the UE receives it after the session is actually deactivated. Therefore, the group paging is considered to be valid.

Proposal 11: RAN2 should agree on the enhanced group paging for multicast session deactivation.

For the details of function enhancement of the group paging, backward compatibility needs to be considered. Since the existing paging group list (i.e., a list of TMGIs) is applicable to legacy UEs, the group paging needs to add a new TMGI list for deactivation notification to avoid an influence on the legacy UEs.

Proposal 12: in a case where the Proposal 11 can be agreed, RAN2 further discusses whether to create a new paging group list configured with the TMGI of the deactivated multicast session.

### 2.4.2. Multicast Session Activation and Selective Transition

RAN2 #119e reached the assumption that the gNB can select a subset of UEs transitioning between inactive and connected.
It is assumed that the network can select which UE receives in the RRC inactive state and in the RRC connected state, and can move the UE between the states for the multicast service reception.

RAN2 #121bis-e agreed to enhance the group paging of session activation notifications.
The Rel-18 UE may remain in the RRC inactive state and start monitoring the corresponding G-RNTI when an enhanced group paging (such as session activation or resume of data transmission) occurs. For the details, further studies are needed.
Legacy group paging (i.e., Rel-17 group paging) may be used to return the UE to the RRC connected state.
A specific MBS multicast UE can be transitioned to the RRC connected (i.e., legacy UE operation) using UE-specific paging (such as PagingRecordList).
When the UE receives both enhanced group paging and unicast paging (and this UE us targeted), the UE follows the unicast paging and transitions to the RRC connected.

As to the enhancement for the group paging, considering that a subset of UEs remains inactive while another subset transitions to connected, the operation of the UE upon receiving the current paging message (i.e., UE-specific paging and group paging) is as follows.
UE-specific paging: The UE transitions to connected when its UE-ID is available in pagingRecordList.
Group Paging: When a TMGI of interest becomes available in pagingGroupList, all UEs transition to connected.
Paging message: pagingRecordList and pagingGroupList can be configured simultaneously (i.e., in one message) in terms of ASN.1. In any case, all UEs transition to connected when the TMGI of interest becomes available in pagingGroupList, regardless of pagingRecordList.

Therefore, the gNB cannot leave the subset of UEs in the inactive state as long as these UEs are interested in the TMGIs available in pagingGroupList.

Therefore, in the Rel-18 function enhancement, the operation of the UE upon receiving the group paging needs to be changed. A simple way is to cancel legacy pagingGroupList, where legacy pagingGroupList is always needed for the Rel-17 UEs (i.e. backward compatibility). Since the cancellation needs to be performed for each TMGI, an additional TMGI list is required (e.g., Paging Group Cancel List is constituted by the TMGIs). Considering the RAN2 agreement item “when both enhanced group paging and unicast paging are received by a UE (and this UE is targeted), the UE follows the unicast Paging and becomes RRC connected”, the operation of the Rel-18 UE is as follows.
Step 1: The UE receives a paging message including pagingRecordList, pagingGroupList, and a new TMGI cancellation list.
Step 2: Since pagingGroupList includes the TMGI of interest, the UE is considered to have been paged by the group paging, as in Rel-17.
Step 3: Since the new TMGI cancellation list includes the TMGI of interest (that is, the same TMGI), the UE considers that the group paging is canceled.
Step 4: Since pagingRecordList includes the UE-ID, the UE considers that it has been paged by the UE-specific paging, and transitions to the connected state as in Rel-17.
Step 5: The gNB configures the UE with multicast MRB as in Rel-17.

Finally, only a subset of UEs transition to connected for multicast reception.

Proposal 13: RAN2 should agree to add a new cancel TMGI list to the group paging to cancel the Rel-17 group paging.

Further study is needed as to the “special UE” in RAN2 #121bis-e.
The “special UE” identified by the MBS assistance information from the 5GC may be released to RRC inactive (such as when the session is deactivated). Further study is needed as to what to do to allow the network to return to RRC connected when such a UE activates the session.

That is, pagingRecordList includes the UE-ID of the “special UE”, and pagingGroupList and the new TMGI cancellation list include the TMGIs of interest of the “special UE”. Thus, enhancement for this is not needed.

Observation 2: The new TMGI cancel list also works for the “special UE” at session activation.

### 2.4.3. Update of PTM Configuration

RAN2 #120 agreed to use the MCCH when the PTM configuration needs to be updated.
The mixed approach proceeds as follows.
5. When the NW configures the UE to continue multicast reception in the inactive state, the NW provides the PTM configuration for the activated multicast session through RRC dedicated signaling to at least the serving cell (other cases need to be further studied).
6. The MCCH is used when the PTM configuration needs to be changed or when the PTM configuration needs to be indicated during migrating beyond the serving cell/gNB. The change of the session status and other indications need to be further studied.
7. Assume that the UE can receive the multicast service after joining the session.
8. Whether the MCCH configuration is initially provided to the UE through dedicated signaling needs to be further studied.

RAN2 #121 agreed to use the RRC release for the PTM configuration (even before the session activation) and to introduce a new MCCH (different from Rel-17 MCCH).
The UE needs to join the multicast session before receiving the multicast in the RRC inactive.
The network may configure the UE with the PTM configuration of the (single) serving cell before the session activation when the network determines that it is useful, and the UE may store the configuration.—When the session is activated, the UE can apply the configuration to receive the multicast in the inactive state without returning to RRC connected unless updated by the MCCH after the configuration.
When the network configures the UE to receive multicast in the inactive state, the PTM configuration can be delivered using an RRC Release message including suspendconfig. No other dedicated RRC message is used to provide the PTM configuration of the MBS multicast in the inactive state.
A new MCCH logical channel for multicast in inactive (different from broadcast MCCH) is introduced.

According to these agreement items, there exist two cases for PTM configuration update.
Case 1: For the UE in inactive receiving already activated multicast session
Case 2: For the UE in inactive waiting for activation of multicast session
Note: Case 2 may be further classified according to whether the PTM configuration has been provided by the RRC release.

In such a case, the solutions are desirably as common as possible.

Proposal 14: RAN2 should aim at the common solution for the notification of the PTM configuration update, considering at least two cases of an already activated session and a session before activation.

The motivation for using the MCCH is to reduce the signaling overhead upon updating the PTM configuration, i.e., to allow the UE to remain in the inactive state to obtain the updated PTM configuration. Therefore, when viewed from the UE in the inactive state, the delivery method of the new PTM configuration in the Rel-18 is similar to the Rel-17 delivery mode 2. In this case, it is considered reasonable to reuse the existing MCCH change notification to perform notification of the update of the PTM configuration.

However, the MCCH Change Notification requires the UE to wake up once per MCCH change boundary, which puts additional load in addition to the monitoring of paging occasions. Also, the MCCH Change Notification is not efficient, especially in case 2 above (i.e. the UE needs to monitor the MCCH Change Notification just waiting for the multicast session notification to confirm whether the PTM configuration provided by the RRC release has been updated).

To solve such problem, the group paging can be enhanced for notification of the PTM configuration update. The UE only needs to monitor the paging occasion to determine whether the PTM configuration has been updated, regardless of whether the UE is receiving a multicast session (i.e., case 1 or case 2 above). Therefore, RAN2 needs to agree to use the group paging for this notification. Further study is needed as to the details of the function enhancement.

Proposal 15: RAN2 should agree to use the group paging for the update of the PTM configuration instead of the existing MCCH change notification.

### 2.5 Service Continuity Upon RRC Resume

The possibility that the UE having already received a multicast session in inactive (i.e., via a broadcast MRB or a new MRB for multicast reception in inactive) is paged and initiates the RRC Resume procedure needs to be considered. After transitioning to connected, the UE of course wants to continue to receive the multicast session. However, in this case, the UE has two MRBs for the same multicast session, namely a broadcast MRB (or a new MRB) configured for multicast reception in inactive and a multicast MRB resumed for multicast reception in connected.

In Rel-17, a multicast session can receive only via a multicast MRB configured by an RRC reconfiguration. On the other hand, in Rel-18, it is considered that the UE can receive a multicast session via a Broadcast MRB (or a new MRB) configured by an RRC reconfiguration or a new MCCH.

The UE needs to use the multicast MRB for reception after transitioning to connected (as in Rel-17). However, it is not clear how the UE switches these MRBs, when the UE discards the broadcast MRB (or new MRB), how the UE should operate when the multicast MRB is an AM MRB (i.e., in terms of lossless principle) and the like. Therefore, RAN2 needs to discuss the operation of the UE upon RRC resume in terms of processing of the MRB and service continuity of the multicast session.

Proposal 16: RAN2 should discuss the operation of the UE that is continuing to receive the multicast session upon RRC resume (such as processing of broadcast MRB and multicast MRB).

### REFERENCE SIGNS

1: Mobile communication system
5: Network
10: RAN
20: CN
100: User equipment (UE)
110: Receiver
120: Transmitter
130: Controller
200: gNB (Base station)
210: Transmitter
220: Receiver
230: Controller
240: Backhaul communicator

1. A communication method performed by a user equipment in a mobile communication system configured to provide a multicast/broadcast service (MBS), the communication method comprising:
receiving, from a network, a plurality of reception quality thresholds for initiating a radio resource control (RRC) connection resume at a time of multicast reception in an RRC inactive state, the plurality of reception quality thresholds being associated with a plurality of multicast sessions;
identifying, from among the plurality of reception quality thresholds, a reception quality threshold associated with a multicast session joined by the user equipment; and
initiating the RRC connection resume in response to the identified reception quality falling below the reception quality threshold at a time of multicast reception in the RRC inactive state.

2. The communication method according to claim 1, wherein
the initiating comprises transmitting an RRC Resume Request message comprising mt-Access as a Resume Cause to the network.

3. A user equipment used in a mobile communication system configured to provide a multicast/broadcast service (MBS), the user equipment comprising:
a receiver configured to receive, from a network, a plurality of reception quality thresholds for initiating a radio resource control (RRC) connection resume at a time of multicast reception in an RRC inactive state, the plurality of reception quality thresholds being associated with a plurality of multicast sessions, and
a controller configured to identify from among the plurality of reception quality thresholds, a reception quality threshold associated with a multicast session joined by the user equipment, wherein
the controller is configured to initiate the RRC connection resume in response to the identified reception quality falling below the reception quality threshold at a time of multicast reception in the RRC inactive state.

4. A chipset for a user equipment used in a mobile communication system configured to provide a multicast/broadcast service (MBS), the chipset configured to execute processing of:
receiving, from a network, a plurality of reception quality thresholds for initiating a radio resource control (RRC) connection resume at a time of multicast reception in an RRC inactive state, the plurality of reception quality thresholds being associated with a plurality of multicast sessions;
identifying, from among the plurality of reception quality thresholds, a reception quality threshold associated with a multicast session joined by the user equipment; and
initiating the RRC connection resume in response to the identified reception quality falling below the reception quality threshold at a time of multicast reception in the RRC inactive state.

5. A non-transitory computer-readable medium comprising, stored thereupon, computer program instructions for execution by a user equipment used in a mobile communication system configured to provide a multicast/broadcast service (MBS), the program instructions being configured to cause the user equipment to execute processing of:
receiving, from a network, a plurality of reception quality thresholds for initiating a radio resource control (RRC) connection resume at a time of multicast reception in an RRC inactive state, the plurality of reception quality thresholds being associated with a plurality of multicast sessions;
identifying, from among the plurality of reception quality thresholds, a reception quality threshold associated with a multicast session joined by the user equipment; and
initiating the RRC connection resume in response to the identified reception quality falling below the reception quality threshold at a time of multicast reception in the RRC inactive state.

6. A mobile communication system configured to provide a multicast/broadcast service (MBS), the mobile communication system comprising:
a network node; and
a user equipment configured to:
receive, from the network node, a plurality of reception quality thresholds for initiating a radio resource control (RRC) connection resume at a time of multicast reception in an RRC inactive state, the plurality of reception quality thresholds being associated with a plurality of multicast sessions,
identify from among the plurality of reception quality thresholds, a reception quality threshold associated with a multicast session joined by the user equipment, and
initiate the RRC connection resume in response to the identified reception quality falling below the reception quality threshold at a time of multicast reception in the RRC inactive state.
